(19) United States
(12) Patent Application Publication
(10) Pub. No.: US 2009/0216775 A1
(43) Pub. Date: Aug. 27, 2009

(54) Platform for real-time tracking and analysis

(76) Inventors: Marc Gregory Ratliff, Lombard, IL (US); Phillip Matthew Paris, Chicago, IL (US); Stephen Gregory Eick, Naperville, IL (US)

Correspondence Address: Carmen Patti Group , LLC, ONE NORTH LASALLE STREET, 44TH FLOOR, CHICAGO, IL, 60602, US

(21) Appl. No.: 12/070,976

(22) Filed: Feb. 22, 2008

(51) Int. Cl. G06F 17/30

(52) U.S. Cl. 707/10; 707/104.1; 707/E17.009; 707/E17.032

(57) ABSTRACT

An apparatus in one example has: at least one of an identification tag and a video feed associated with at least one asset; at least one real time location server that operatively interfaces with the at least one of the identification tag and the video feed; and real-time data analysis and tracking system that ingests asset location data for at least one asset from at least one real time location server. The real time data analysis and tracking system may have a real-time alerting rules engine. Assets being tracked may be organized into at least categories and groups, the categories may be used to manipulate visibility of sets of assets in a portal, and the groups may be used by the real-time alerting rules engine.

### CROSS-REFERENCE TO RELATED APPLICATIONS

This application is related to U.S. patent application Ser. No. 11/670,859, filed Feb. 2, 2007, which is hereby incorporated by reference.

This application is related to U.S. patent application Ser. No. 11/725,119, filed Mar. 16, 2007, which is hereby incorporated by reference.

This application is related to U.S. patent application Ser. No. 12/005,334, filed Dec. 26, 2007, which is hereby incorporated by reference.

### FIELD OF THE INVENTION

This invention is directed to systems using radio frequency identification and real time location tracking.

### BACKGROUND

Recently with the widespread deployment of GPS, RFID, and other tagging technologies it has become possible to collect large quantities of geo-encoded information. Some of the information contains true sequences of longitude and latitude positions of a moving object. Other information is less precise and only indicates that an object passed through a reader, e.g. a car with an RFID IPass tag passing through a tollbooth. Although GPS and RFID are perhaps the most widely recognized location systems, they are examples of what is rapidly becoming a wide variety of sensor and tagging systems that provide real-time location information.

Real-Time Location Systems use RFID tags, readers, and sensor systems to triangulate the positions of objects. The triangulation algorithms use amplitude, energy levels, time-of-flight, and different time-of-flight, maps of aisles, and other related technologies to determine a tag's location with respect to other tags and coordinates. Because of their wireless nature, Real-Time Location Systems can be used to solve a wide range of problems. For example:

Locating pallets or containers that have been misplaced in a large warehouse;

Determining the location of expensive tools or capital equipment, thereby increasing asset utilization and saving on capital costs;

Managing in-process inventory or finding an exact part among many similar parts;

Tracking personnel movements within high-security facilities;

Monitoring vehicles passing through security checkpoints; and

Minimizing theft for organizations with high-value mobile assets.

As the Real-Time Location Systems market continues to take shape, the growth of Real-Time Location Systems from a niche solution to an enterprise application is being powered by the increasing number of WLAN, Wi-Fi, GPS, and UWB deployments in diverse fields such as manufacturing, logistics, retail, hospitals, defense, etc.

GPS is a type of Real-Time Location Systems technology and is widely used for tracking vehicles and is now being embedded in cell phones. However, GPS is not appropriate for tracking hundreds or thousands of tags in a fixed space, especially indoors. The reason is that GPS receivers require line of sight access to satellites to calculate their positions. GPS radio signals, emanating from geosynchronous satellites, cannot penetrate most building materials. Furthermore, current GPS systems generally provide location information that is less accurate as other Real-Time Location Systems technologies. Since most of the world's commerce takes place indoors, GPS Real-Time Location Systems are limited to tracking vehicles and high-value outdoor assets.

For indoor Real-Time Location Systems there are a variety of technologies, each of which have its own error characteristics and would be appropriate for different applications. For example, Ultrawide Band (UWB) systems use extremely short duration bursts of radio frequency (RF) energy—typically ranging from a few hundred picoseconds (trillionths of a second) to a few nanoseconds (billionths of a second) in duration. UWB technology supports read ranges in excess of 200 meters (650 feet), resolution and accuracies of better than 30 cm (1 foot), tag battery lifetimes in excess of 5 years. UWB systems work well in industrial and hospital applications where multi-path echoing environments. Multi-path cancellation occurs when a strong reflected wave, e.g. off a wall, file cabinet, ceiling, vehicle, arrives partially out of phase with the direct signal causing a reduced amplitude response at the receiver. The reason these systems work well in this environment is because with very short pulses the direct path has essentially come and gone before the reflected path arrives and no cancellation occurs.

“Web 1.0” is the term associated with the first generation of internet browser applications and programs, along with the associated client-side software entities and server-side software entities used to support and access information using the Internet. Such Web 1.0 technologies, like most first-generation technologies, are geared more to enabling a workable system and to the capabilities of the available software and hardware platforms, rather than to creating a rich and efficient experience for the system's users. Thus, conventional Web 1.0 technologies, while efficient for machines, are often highly inefficient and frustrating for their human users.

In particular, Web 1.0 technologies operate on a “click-wait” or a “start-stop” philosophy. That is, when a user wishes to view a web page, the user must generate a request using the client-side browser software, and send that request to the server. The user must then wait for the server to respond to the request and forward the requested data. The user must further wait for all of the requested data to be received by the client-side browser software and for the browser software to parse and display all of the requested information before the user is allowed to interact with the requested web page.

This is frustrating for most users on a number of levels. First, for slow or bandwidth-limited Internet connections, obtaining all of the requested data can often take a relatively long time. Furthermore, even when the user has high-speed access to the Internet, a web page that requires data to be re-loaded or refreshed on a fairly regular basis, such as mapping web pages, sporting events scores, or play-by-play web pages and the like, can cause significant delays. This is typically due to Web 1.0 requirements that the entire web page be retransmitted even if no or only minimal changes have occurred to the displayed information.

Accordingly, the next generation of technologies used to access and support the Internet is currently being developed and collected under the rubric “Web 2.0”. A key feature in the “Web 2.0” concept is to eliminate the above-outlined “click-wait” or “start-stop” cycle, by asynchronously supplying data associated with a particular web page to the user from the associated web server. The transfer occurs as a background process, while a user is still viewing and possibly interacting with the web page, which anticipates the fact that the user will wish to access that asynchronously-supplied data. A number of important technologies within the “Web 2.0” concept have already been developed. These include “AJAX”, SVG, and the like.

Asynchronous JavaScript and XML, or “AJAX”, is a web development technique used to create interactive web applications. AJAX is used to make web pages feel more responsive by exchanging small amounts of data between the client application and the server as a background process. Accordingly, by using AJAX, an entire web page does not have to be re-loaded each time a portion of the page needs to be refreshed or the user makes a change to the web page at the client side. AJAX is used to increase the web page's interactivity, speed, and usability. AJAX itself makes use of a number of available techniques and technologies, including XHTML (extended hypertext markup language) and CSS (cascading style sheets), which are used to define web pages and provide markup and styling information for the web pages. It also makes use of a client-side scripting language, such as JavaScript, that allows the DOM (document object model) to be accessed and manipulated, so that the information in the web page can be dynamically displayed and can be interacted with by the user.

Other important technologies include the XMLHttpRequest object, which is used to exchange data asynchronously between the client-side browser software and the server supporting the web page being displayed, and XML, RSS and other data exchange standards, which are used as the format for transferring data from the server to the client-side browser application. Finally, SVG (scalable vector graphics) is used to define the graphical elements of the web page to be displayed using the client-side browser application.

In addition to Web 1.0 and Web 2.0 technologies, an entirely different set of software technologies are used to access other data available over local area networks, wide area networks, the internet and the like. These technologies are traditionally referred to as “client-server applications”, where a complex software application having a rich set of features is installed on a particular client computer. This software application executes on the client computer and is used to access, display and interact with information stored on a server that is accessed via a local area network, a wide area network, the Internet or the like. While such client-server applications allow for dynamic displays and make manipulating information easy, such client-server applications are difficult to deploy to all of the client machines, and are difficult to update.

### SUMMARY

One embodiment of the present method and apparatus encompasses an apparatus. This embodiment of the apparatus may comprise: at least one of an identification tag and a video feed associated with at least one asset; at least one real time location server that operatively interfaces with the at least one of the identification tag and the video feed; and real-time data analysis and tracking system that ingests asset location data for at least one asset from at least one real time location server.

Another embodiment of the present method and apparatus encompasses an apparatus. This embodiment of the apparatus may comprise: at least one location server having at least one output that provides asset location data related to at least one asset; normalization system having at least one input operatively coupled respectively to the output of the at least one location server, and having at least one output for providing normalized location data; and tracking and processing system having at least one input operatively coupled respectively to the at least one output of the normalization system, and having at least one output for providing tracked asset information.

Another embodiment of the present method and apparatus encompasses a method. This embodiment of the method may comprise: receiving, in a first layer, asset location data related to at least one asset from a variety of real-time location servers; accepting, in a second layer, the data from the first layer and normalizing positions of the asset, de-conflicting the positions of the assets, and persisting resulting asset information in a geospatial database; tracking and processing, in a third layer, the at least one asset based on the asset information from the second layer, and providing tracked asset information; analyzing and managing, in a fourth layer, the tracked asset information from the third layer to provide reportable information regarding the at least one asset; and providing, in a fifth layer, user interfaces to the reportable information of the fourth layer.

Another embodiment of the present method and apparatus encompasses an apparatus. This embodiment of the apparatus may comprise: a fusion server having a plurality of location ingestors operatively coupled respectively to a plurality of real time location servers; a tracking server operatively coupled the fusion server, the tracking server having real-time alerting rules engine and workflow integration, the tracking server also having a position readings database, a zones database and a business rules and alert definitions database; and a web 2.0 portal having an AJAX portal.

Another embodiment of the present method and apparatus encompasses an apparatus. This embodiment of the apparatus may comprise: at least one asset and associated asset location data; at least one map; real-time tracking system that shows, based on the associated location data, a position of the at least one asset on the at least one map; and asset organization system operatively coupled to the real-time tracking system.

Another embodiment of the present method and apparatus encompasses an apparatus. This embodiment of the apparatus may comprise: at least one asset and associated asset location data; at least one map; real-time tracking system that shows, based on the associated location data, a position of the at least one asset on the at least one map and on at least one time line; asset organization system operatively coupled to the real-time tracking system; and alerting engine operatively coupled to at least the asset organization system, the alerting engine generating at least one alert for at least one predetermined action related to the at least one asset.

Another embodiment of the present method and apparatus encompasses an apparatus. This embodiment of the apparatus may comprise: at least one asset and associated asset location data; at least one map; real-time tracking system that shows, based on the associated location data, a position of the at least one asset on the at least one map; and video integration system that provides spatial and situational awareness of an asset operatively coupled to the real-time tracking system, the video integration system providing access to real-time streaming video feeds directly from a portal by clicking on icons embedded in the map.

Another embodiment of the present method and apparatus encompasses an apparatus. This embodiment of the apparatus may comprise: at least one asset and associated asset location data; at least one map; real-time tracking system that shows, based on the associated location data, a position of the at least one asset on the at least one map; and a geofencing engine that establishes a defined area, a geofence, on the map; wherein an asset crossing the geofence is detectable.

Another embodiment of the present method and apparatus encompasses an apparatus. This embodiment of the apparatus may comprise: a tracking system that ingests asset location data of assets from a plurality of real time location servers; the tracking system having: a fusion engine that ingests, normalizes, de-conflicts, and persists real time location server feed information to provide accurate locations of the assets; a real-time geospatial tracking database that includes asset information; and an alerting engine with configurable rules; wherein the apparatus uses both outside maps and inside maps to show asset positions, and connects to at least one of “push” and “pull” feeds.

Another embodiment of the present method and apparatus encompasses an apparatus. This embodiment of the apparatus may comprise: a plurality of radio frequency identification tags attached respectively to a plurality of animals; plurality of real time location servers that provide asset location information based at least on the radio frequency identification tags on the animals; at least one map and at least one timeline; real-time tracking system that shows, based on the asset location data, positions of the animals on the at least one map and on at least one time line; and alerting engine operatively coupled to at least the real-time tracking system, the alerting engine generating at least one alert for at least one predetermined action related to positions of the animals.

### BRIEF DESCRIPTION OF DRAWINGS

The features of the embodiments of the present method and apparatus are set forth with particularity in the appended claims. These embodiments may best be understood by reference to the following description taken in conjunction with the accompanying drawings, in the several figures of which like reference numerals identify like elements, and in which:

FIG. 1 depicts according to the present method and apparatus one embodiment of the thincTrax system architecture, which consists of five layers.

FIG. 2 depicts in general terms one embodiment according to the present method.

FIG. 3 depicts that the thincTrax system may have a FUSION engine.

FIG. 4 depicts one embodiment in which portal may show object positions on a map substrate and may use a “breadcrumb” trail.

FIGS. 5 and 6 in one embodiment according to the present method and apparatus depict several ways to locate objects and some user interface features.

FIG. 7 shows that the thincTrax system may also have Video Integration that provides spatial and situational awareness.

FIG. 8 depicts a geo-fenced region according to the present method and apparatus.

FIGS. 9 and 10 show an example of a user configuring a rule according to the present method and apparatus.

FIG. 11 depicts an alert analysis that identifies relationships among the assets, categories, geospatial positions, and alerts.

FIG. 12 shows a heat map analysis with, for example, heat map colors encoding the amount of time objects spend in zones.

FIG. 13 shows the thincTrax system forensic analysis capability.

FIG. 14 is a block diagram of the tracking feature of the present method and apparatus.

FIG. 15 is a block diagram showing the alerting feature of the present method and apparatus.

FIG. 16 is a block diagram showing the video feature of the present method and apparatus.

FIG. 17 is a block diagram showing the geo-fencing feature of the present method and apparatus.

FIG. 18 depicts one embodiment of the thincTrax system architecture.

FIG. 19 depicts another embodiment of the thincTrax software architecture.

FIG. 20 depicts an embodiment of the thincTrax RTLS ingest server.

FIG. 21 depicts an embodiment of the thincTrax tracking server architecture.

FIG. 22 depicts a flow diagram of an embodiment of the procedures for ingesting data from the RTLS's.

FIG. 23 depicts one embodiment of the asset tables.

FIG. 24 depicts one embodiment of the constraint and alert tables.

FIG. 25 depicts one embodiment of the zone tables.

### DETAILED DESCRIPTION

The following terms are used in the description of the present apparatus and method.

RSS (formally “RDF Site Summary”, known colloquially as “Really Simple Syndication”) is a family of Web feed formats used to publish frequently updated content such as blog entries, news headlines or podcasts. An RSS document, which is called a “feed”, “web feed”, or “channel”, contains either a summary of content from an associated web site or the full text.

GeoRSS is an emerging standard for encoding location as part of an RSS feed. (RSS is an XML format used to describe feeds (“channels”) of content, such as news articles, MP3 play lists, and blog entries. These RSS feeds are rendered by programs such as aggregators and web browsers.) In GeoRSS, location content consists of geographical points, lines, and polygons of interest and related feature descriptions. GeoRSS feeds are designed to be consumed by geographic software such as map generators.

Representational State Transfer (REST) is a style of software architecture for distributed hypermedia systems such as the World Wide Web. REST refers to a collection of network architecture principles that outline how resources are defined and addressed. The term is often used in a looser sense to describe any simple interface that transmits domain specific data over HTTP without an additional messaging layer. An important concept in REST is the existence of resources (sources of specific information), each of which can be referred to using a global identifier (a URI). In order to manipulate these resources, components of the network (clients and servers) communicate via a standardized interface (e.g. HTTP) and exchange representations of these resources (the actual documents conveying the information). The World Wide Web is the key example of a REST design. Much of it conforms to the REST principles. The Web consists of the Hypertext Transfer Protocol (HTTP), content types including the Hypertext Markup Language (HTML), and other Internet technologies such as the Domain Name System (DNS).

GData provides a simple standard protocol for reading and writing data on the Internet. GData combines common XML-based syndication formats (such as, RSS) with a feed-publishing system.

In any complex application many different Real-Time Location Systems may be deployed. For example, in a hospital environment there could be a Real-Time Location System for tracking ambulances. Within the emergency room there may be an Real-Time Location Systems tracking patients to ensure that no one waits too long. For a patient receiving treatment a Real-Time Location Systems may track the patient's progress down the hospital corridors and another may track the patient and critical equipment within the operating room. Each of these heterogeneous systems generates streams or location information that must be fused and combined rated to provide actionable information. To address this opportunity, a software platform called thincTrax™, according to the present method and apparatus, ingests real-time location information.

The thincTrax system is a Real-time Tracking and Analysis System. The thincTrax system may interface with a variety of Real-Time Location Systems, may fuses, de-conflicts, normalizes, and persist positional information, and may provide real-time management and forensic analysis of geospatial object positions. By fusing information from disparate sensor systems, thincTrax provides an integrated view of object positions that is persisted in a geospatial database. Using the integrated view of object positions the thincTrax portal and rule-based alerting engine provides a management capability. The management capability is rich and the system can be configured so that rules fire when objects enter or leave geo-fenced regions. Furthermore, the thincTrax real-time tracking and analysis platform includes analytical tools and a reporting module to correlate the historical object positions and provide a forensic analysis capability.

Some of the unique capabilities and benefits of thincTrax are:

Accepts live position data from a variety of sources including RFID, GPS, and other Real-Time Location Systems;

Fuses, de-conflicts, normalizes, and persists the location information to provide an accurate position information for each object;

Includes a rule-based alerting engine with geo-fences to assets, locations, zones, etc. and provides alert notification in multiple formats;

Shows the positions of objects, assets, personnel, or vehicles in a Web 2.0 portal with breadcrumb paths on a geospatial substrate such as a map, building floor plan, warehouse layout, etc.

Provides forensics, replay capability, and time-based visual intelligence tools for analyzing the historical positions of objects and showing the progression of an incident;

Supports PDAs and Tablets for mobile users;

Provides for real-time collaboration among distributed users; and

Interfaces with video and other collection systems.

Instead of focusing on only tagging technologies and vertical solutions, embodiments of the present method and apparatus provide a generic software layer on top of all tracking systems.

The thincTrax embodiment, according to the present method and apparatus, is a full-featured real-time analysis and tracking system. It captures position data from multiple real time location servers (RTLS's), normalizes, de-conflicts, and persists the information into a geospatial database. The reason for the normalization and de-confliction is that the each RTLS may provide position information in its own coordinate systems, will have different error characteristics, and may provide conflicting positions.

In Web 2.0 a transfer occurs as a background process, while a user is still viewing and possibly interacting with the web page, which anticipates the fact that the user will wish to access that asynchronously-supplied data. A number of important technologies within the Web 2.0 concept have already been developed. These include “AJAX”, SVG, and the like.

Asynchronous JavaScript and XML, or “AJAX”, is a web development technique used to create interactive web applications. AJAX is used to make web pages feel more responsive by exchanging small amounts of data between the client application and the server as a background process. Accordingly, by using AJAX, an entire web page does not have to be re-loaded each time a portion of the page needs to be refreshed or the user makes a change to the web page at the client side. AJAX is used to increase the web page's interactivity, speed, and usability. AJAX itself makes use of a number of available techniques and technologies, including XHTML (extended hypertext markup language) and CSS (cascading style sheets), which are used to define web pages and provide markup and styling information for the web pages. It also makes use of a client-side scripting language, such as JavaScript, that allows the DOM (document object model) to be accessed and manipulated, so that the information in the web page can be dynamically displayed and can be interacted with by the user.

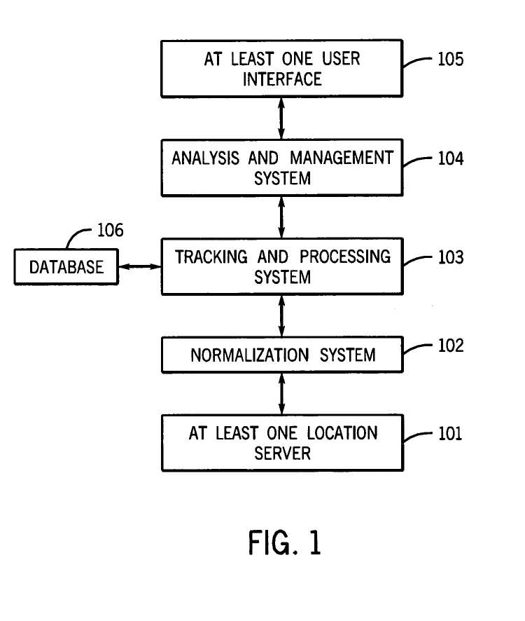

FIG. 1 depicts according to the present method and apparatus one embodiment of the thincTrax system architecture, which consists of five layers.

The first layer 101 consists of a variety of real time location servers that provide data. The reason for this is that no single tracking technology works in every situation. Thus a typical implementation will ingest position information from several sensor systems.

The second layer is a Location Ingest and Normalization layer, also referred to as normalization system 102. The Location Ingest and Normalization layer 102 accepts generic position information from the RTLS's. Using, for example, a fusion engine, the system normalizes the positions, de-conflicts the positions, and persists the information in a geospatial database. The problem is that the RTLS's have different precision characteristics and will report different positions for the same object in a variety of formats. For example, sample formats may be longitude and latitude for objects tracked with GPS, X and Y coordinates for object tracked with active RFID tags inside a building, or specific time-stamped locations as tagged objects pass through readers. The role of the fusion engine is to normalize and de-conflict the feeds to provide an integrated view of object positions.

The third layer is a tracking and processing system 103. After the object or asset positions are determined and persisted in thincTrax's geospatial database 106, the tracking layer 102 processes the new positions, applies business rules, fires alerts, and takes action by integration with workflow management systems.

The fourth layer is an analysis and management system 104. The analysis and management layer provides situational awareness, historical analysis, and reports. This information is presented to users in a lightweight Web 2.0 portal. The portal shows where objects are, where they have been, and provides the capability to find objects.

The fifth layer consists of user interfaces 105, such as application templates. The thincTrax application templates provide customized user interfaces for particular market verticals. This involves changing the dialogues, creating vertical specific rules, and tailoring the software.

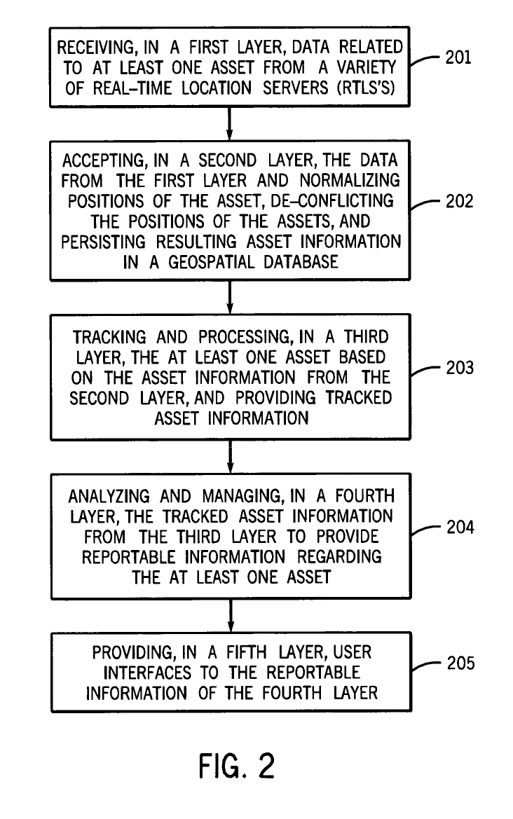

FIG. 2 depicts in general terms one embodiment according to the present method that may have the following steps: receiving, in a first layer, data related to at least one asset from a variety of real-time location servers (step 201); accepting, in a second layer, the data from the first layer and normalizing positions of the asset, de-conflicting the positions of the assets, and persisting resulting asset information in a geospatial database (step 202); tracking and processing, in a third layer, the at least one asset based on the asset information from the second layer, and providing tracked asset information (step 203); analyzing and managing, in a fourth layer, the tracked asset information from the third layer to provide reportable information regarding the at least one asset (step 204); and providing, in a fifth layer, user interfaces to the reportable information of the fourth layer (step 205).

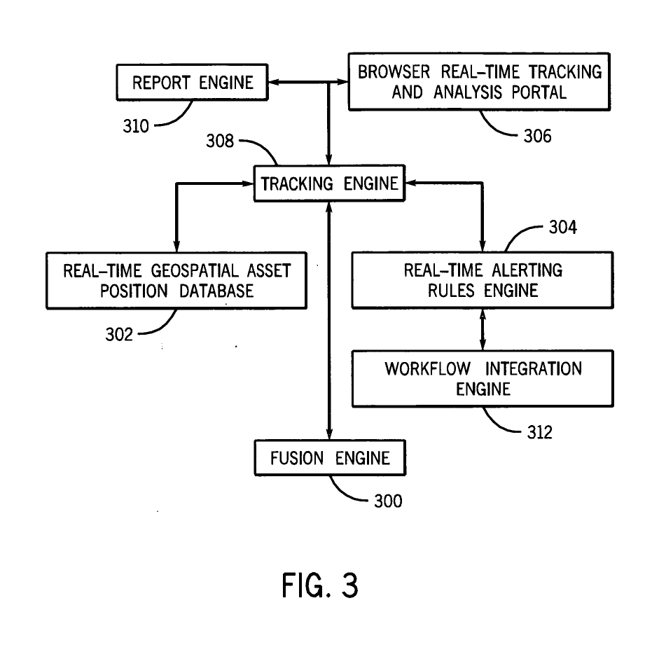

FIG. 3 depicts that the thincTrax system may have a FUSION engine 300 that integrates the information to provide a single object position. For example, in the hospital scenario position information from the RTLS tracking the ambulance will need to be fused with the emergency and operating room RTLS's to provide a continuous view of a patients position.

The thincTrax system may include the FUSION engine 300, a real-time geospatial object position database 302, a real-time alerting rules engine 304, a Web 2.0 real-time tracking and analysis portal 306, a tracking engine 308, a report generator 310, and a workflow integration module 312. The thincTrax system organizes the objects being tracked into categories and groups. The categories are used to manipulate the visibility of sets of objects in its portal and the groups are used by its real-time rules engine.

The thincTrax system may store the current and historical object positions in a geospatial database. In one embodiment the database consists of approximately 25 tables. In this embodiment the most important tables in the database are:

Assets being tracked;

Categories of assets for portal visibility;

Groups of assets for alerting engine;

Current and historical asset locations;

Zones;

Business Rules; and

Alerts.

The thincTrax system may have a Location Ingest and Alerting Engine. The thincTrax system is highly scalable, and may ingest asset position information through both push and pull methods. For push feeds thincTrax is alerted when position information arrives and for pull feeds periodically requests new asset locations from the feed. New object positions are passed to the FUSION engine that normalizes, de-conflicts, and persists the positions to the thincTrax location table. Each time an asset moves it causes the alerting engine to process the rules for the relevant groups of assets, and, if any rules are satisfied, to generate an alert. The alerts and new asset positions are integrated with a Web 2.0 real-time portal so that the current asset positions are shown on the portal within a second or two.

In one embodiment the thincTrax portal is a full-featured Web 2.0 AJAX portal that performs three broad functions accessed via the top menu bar. These are (a) Real-time Tracking, (b) Reports and Analysis, and (c) Configuration and Alerting.

In one embodiment for real-time tracking, the portal may show position objects on top of a satellite image, map, floor plan, warehouse layout, aisle in a store, etc. The map is interactive and supports smooth panning and zooming and automatically updates when new position information becomes available. The portal is flexible and has many options (left) to determine which assets are shown to avoid display clutter. The tabbed pane (bottom) displays alerts, an event timeline, and includes analysis charts. Using the portal analysts may search for individual assets and organize similar assets into groups.

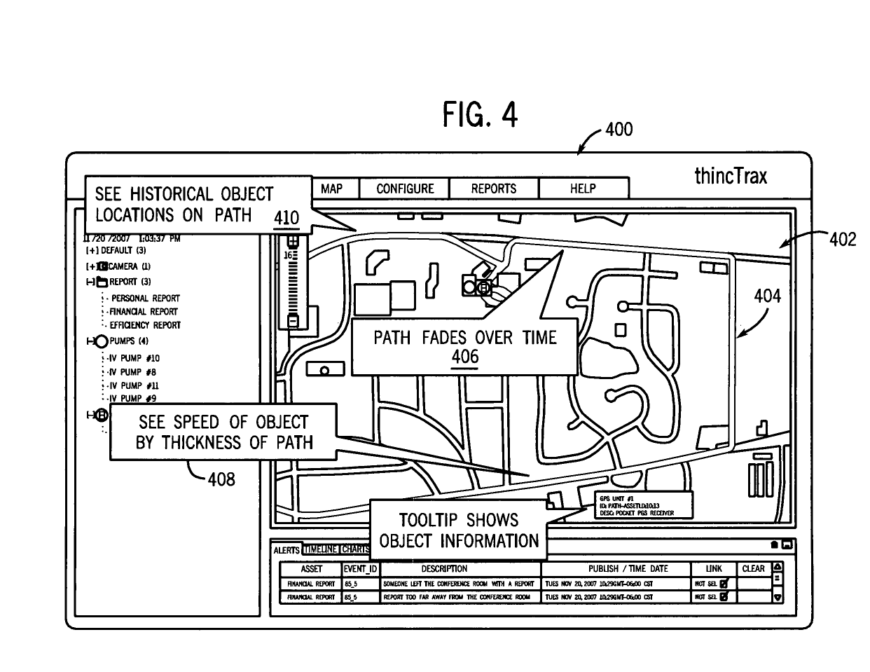

FIG. 4 depicts one embodiment in which the portal 400 may show object positions on a map substrate 402 and may use a “breadcrumb” trail 404 encoded with visual cues to show the object's historical positions. First, history in the trail may be encoded using lightness (see 406). The trail may gradually fade out over time to prevent the display from becoming overly busy. Second, the thickness of the trail may vary to encode the speed of the asset at that particular point (see 408). A thin segment in the trail may indicate that the asset was moving fast and a thick segment may indicate a slower speed. Third, the trail may encode the various points where the object stopped using filled circles (see 410).

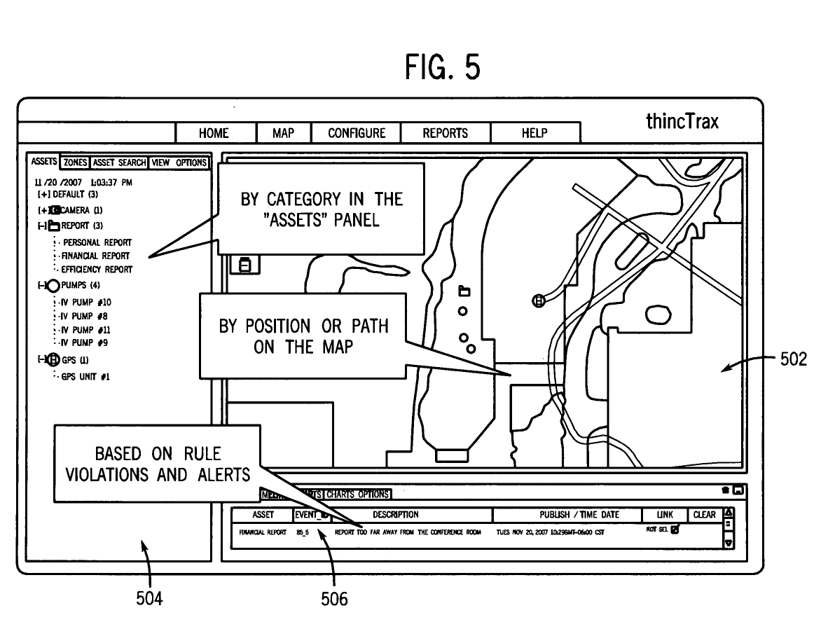

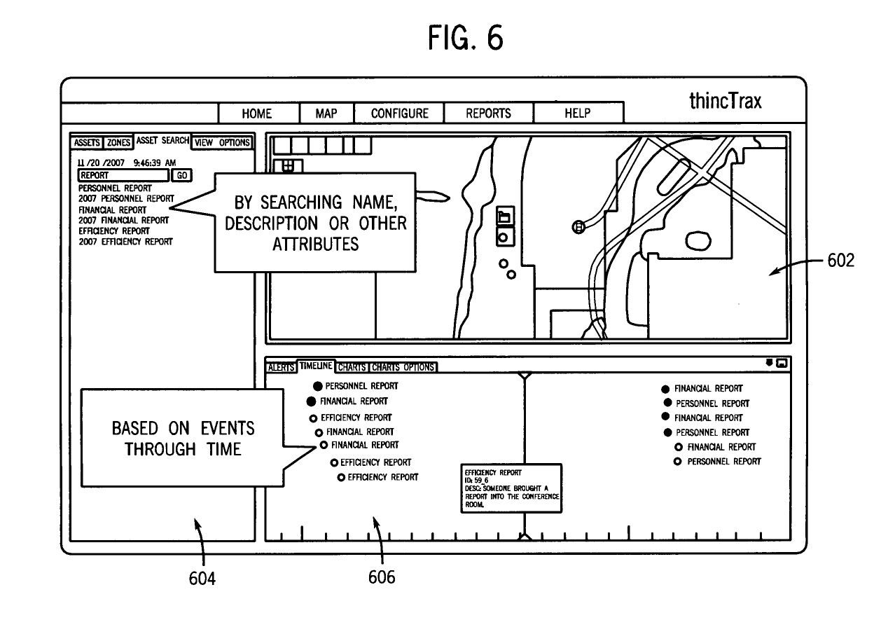

FIGS. 5 and 6 in one embodiment according to the present method and apparatus depict several ways to locate objects and some user interface features. FIG. 5 depicts a map 502, an assets panel 504 and a panel 506 that shows rule violations and alerts. FIG. 6 depicts a map 602, an asset search panel 604 and a timeline panel 606.

For example, clicking on any object on the timeline or alert grid causes the map to pan to the object. Objects are linked among the views using visual cues including tooltips and color. Mousing over an object on any of the views causes it to highlight on the views and thereby helps users identify the object. The portal supports tooltips, linking between the screen components, and smooth panning and zooming. It is completely browser based and supports the Ajax style interaction popularized by Google Maps.

When the alerting engine generates an alarm it appears on the alerts tab on the real-time map, generates an audio ping, and on the timeline. The representations of the alert are linked so that mousing over the alert on the timeline or alerts pane causes the object generating the alert, its location, and its breadcrumb trail to highlight on the map. The left image in FIG. 2 shows alerts on the alert tab and the right image shows an expanded view of alerts on the timeline.

Besides linking alerts between the components on the screen, thincTrax has several other innovative user interface features. These include:

Linking alerts between the map, timeline, and alerts tab;

Saving portal state so that the browser launches with the same options selected the next time the web app comes up; and

Audio tone to indicate a new alert has been fired.

The thincTrax system may include a reporting tool that enables users to create reports of object positions, positions by object category, objects by alert, etc. with filters to limit the report by zone and date range. Implementation of the reporting tool may use Crystal Reports, a well known reporting tool, which attaches to the thincTrax database. With this architecture it is possible to create reports using any of the tables defined in the thincTrax database. This includes creating reports by zones, by rules, by assets, alerts by zone, alerts by assets, etc.

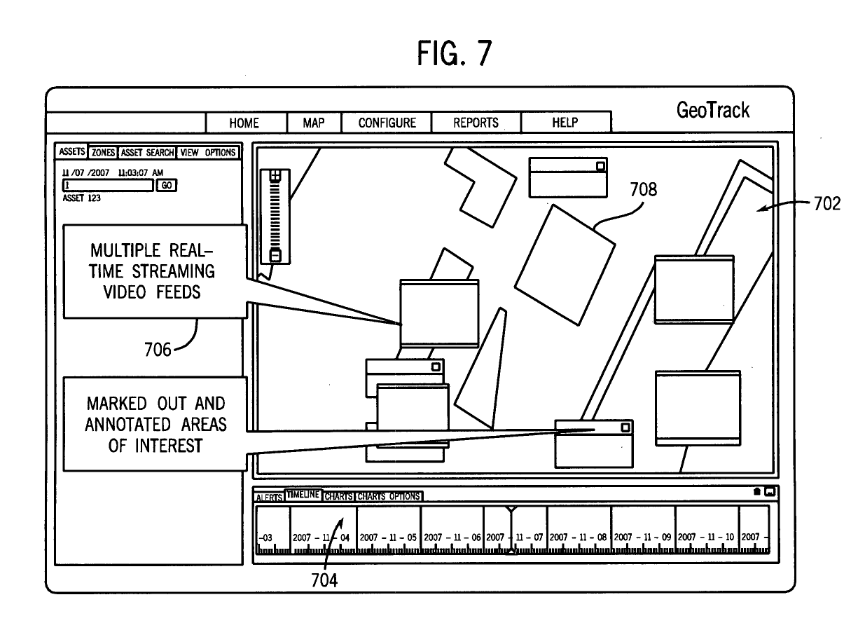

FIG. 7 shows that the thincTrax system may also have Video Integration, for example IP video, that provides spatial and situational awareness. FIG. 7 depicts a map 702 and a timeline 704. Users may access real-time streaming video feeds 706 directly from the portal by clicking on icons embedded in the map 702. The video feeds 706 access cameras at the particular locations indicated by the icon on the map 702. In one implementation the video feeds 706 are not synchronized with the timeline 704. In other embodiments according to the present method and apparatus the video feeds 706 may be integrated with the timeline 704 to provide both spatial and video forensics of an historical incident.

The thincTrax alerting engine may be configurable and may be programmed to trigger based upon movement, speed, entry or egress from a geo-fenced region 708, relationship to other objects, loss of tracking signal, etc. In one embodiment the way the engine works is that there are currently nine rule templates. The rule templates are:

Asset Close to Asset;

Asset Close to Zone;

Asset Enter/Leave Zone;

Asset Not Moving;

Asset Speeding;

Maintain Asset Signal;

Zone Population;

Day of Week; and

Time of Day.

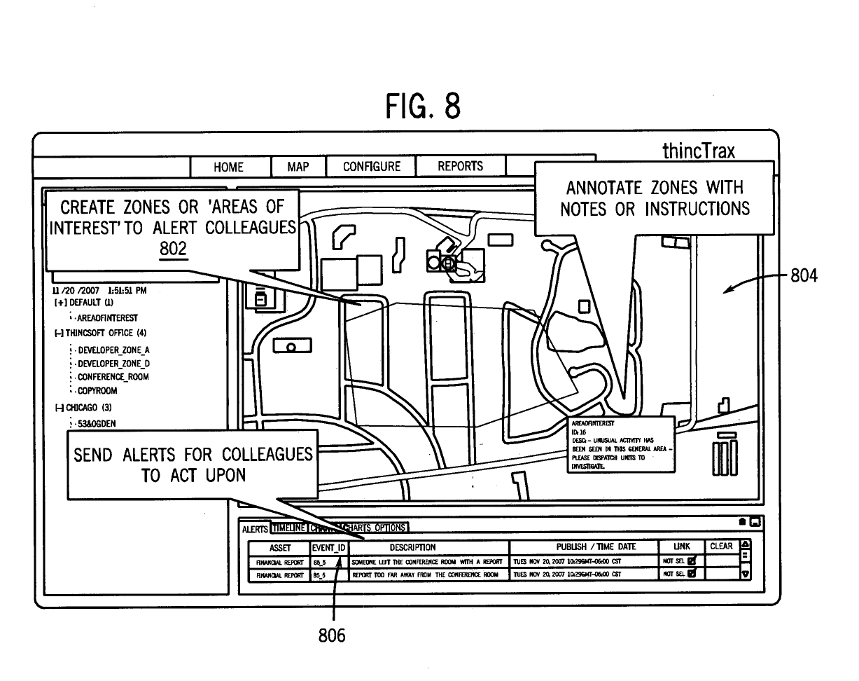

FIG. 8 depicts a geo-fenced region according to the present method and apparatus. A geo-fenced region 802 is defined on a map 804. Also, depicted is the alert panel 806.

Each rule template contains parameters that are configured by users that involve tracking variables. When a template is configured, it becomes a rule. Simple rules may be combined to create composite rules. Rules are named. Every time an object moves, the rules engine recalculates its internal tracking variables and evaluates all of the relevant rules. If any rule is satisfied, an alert is generated and persisted in the alerts table, an audio alarm occurs in the portal, the alert appears on the alerts panel 806 and in the timeline, and, if configured, an email or text message is sent to an address specified in the rules configuration template.

To configure a rule, users specify the group of assets (or all) that the rule applies to, select the rule template, and set the parameters for the rule. For example the user may configure an alert based on a geo-fenced region 802. The geo-fenced region 802 has been previously defined and labeled using the map portal. In this example an alert occurs when an asset moves into or out of the geo-fenced region 802.

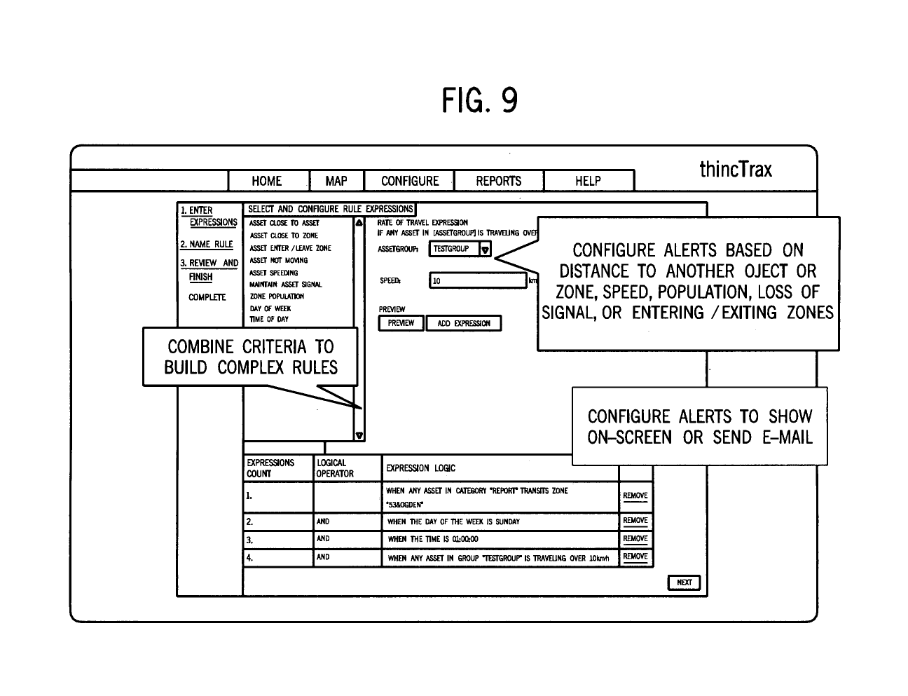

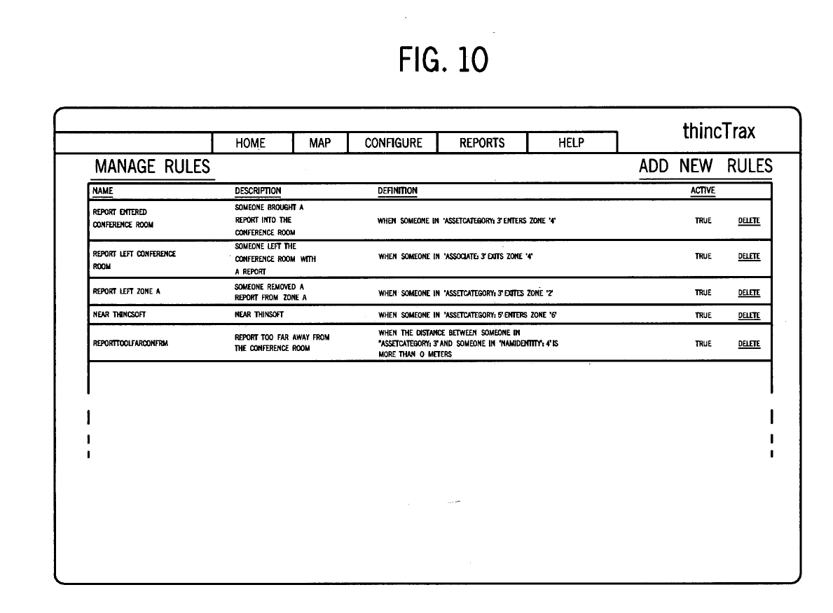

FIGS. 9 and 10 show an example of a user configuring a rule according to the present method and apparatus. In this embodiment each type of rule is a template that is bound with parameters, named, and fed to the alerting engine. Since individual rules may be combined to create composite rules, it is possible to create arbitrarily complex rules.

The purpose of thincTrax□s workflow integration is to interface with other back-office systems to take various actions. For example, thincTrax might integrate with an inventory system for supply chain management, with a hospital billing system to charge for equipment utilization, or with a warehouse management system that maintains the locations of objects in the warehouse.

The thincTrax system supports three types of analysis. The first, alert analysis, involves correlating alerts with assets, zones, rules and other entities generating the alerts using linked analysis components.

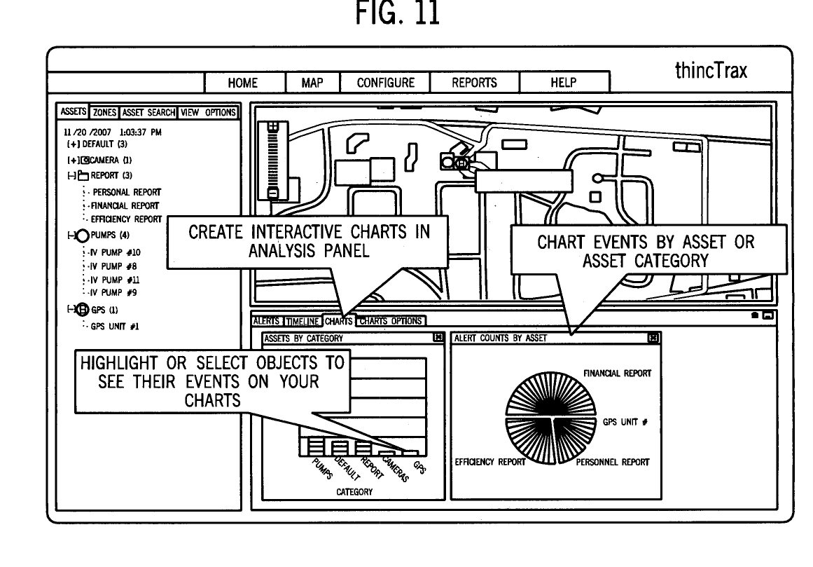

FIG. 11 depicts an alert analysis that identifies relationships among the assets, categories, geospatial positions, and alerts. For example, the bar chart shows the numbers of assets in each asset category and the pie chart shows the number of alerts generated by each asset category. As shown by the pie chart, the “Financial Report” asset category generated nearly 50% of alerts whereas the first three groups of assets each generated approximately the same number of alerts. The charts are interactive and linked. Selecting the GPS asset group on the bar chart highlights all GPS alerts on the pie chart and all of the GPS objects on the map.

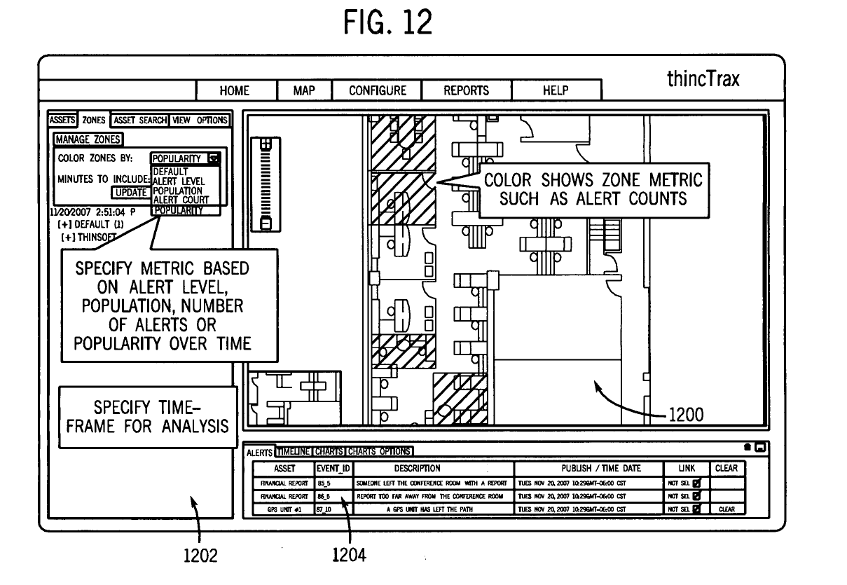

FIG. 12 shows a heat map analysis with, for example, heat map colors encoding the amount of time objects spend in zones. The map 1200 is an inside map, that is it may be an electronic version of the buildings floor plan. The thincTrax system heat map 1200 encodes statistics by mapping the statistic to a color scale and coloring each zone according to the statistic. The zone panel 1202 provides that a metric may be specific base one alert level, population, number of alerts or popularity over time. An alert panel 1204 is also depicted. In this example the possible statistics for the heat map 1200 are “Alert Level”, “Alert Count”, “Popularity”, and “Population.”

Path analysis involves studying the sequence of locations that an asset traverses and identifies common and unusual paths. Common paths might, for example, involve sequence of roads traversed for vehicle tracking applications or aisles for tracking within a warehouse. Path analysis also includes speed along a route, common stopping points, choke points, and other characteristics of the route. One application of path analysis involves monitoring livestock, e.g. cows, within a farm. The productivity of an animal is tied to the amount of time the animal spends in the sun, the locations of the feed troughs, the animal's water, etc. By tagging an animal and tracing its path, it is possible to redesign feedlots to improve efficiency process.

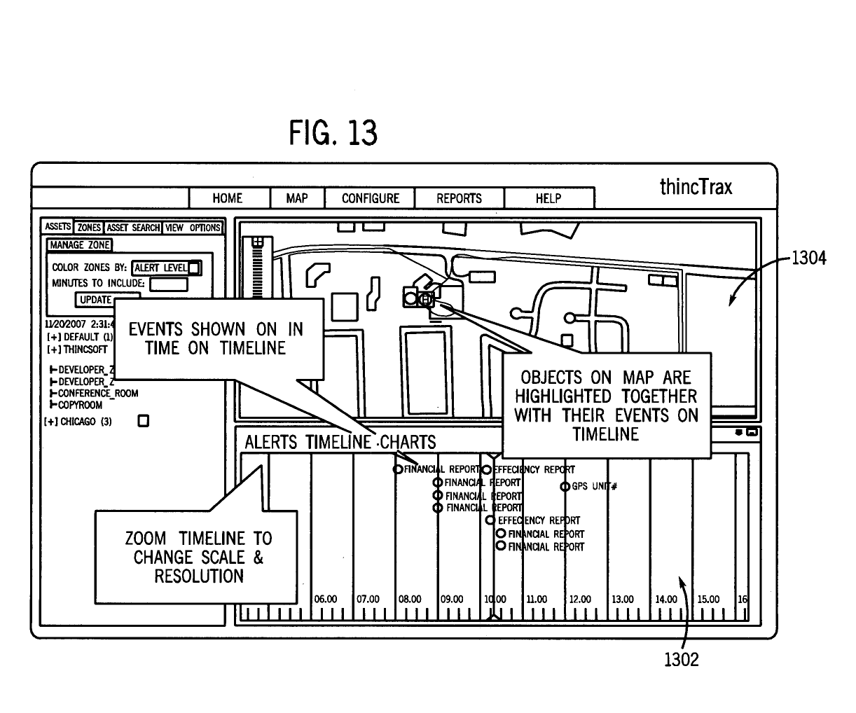

FIG. 13 shows the thincTrax system forensic analysis capability. The timeline 1302 shows the sequence of events during an incident and the corresponding object positions on the map 1304. Mousing over any object shows its geospatial position.

In a further embodiment the thincTrax system may have a forensics capability that may include a replay capability. Position of an asset may be linked with the timeline 1302, enabling the user to move forward and backward in time to show the locations of the assets at particular points in time, show time-laps speed, and have an automated replay capability. Camera feeds may be tied to the timeline 1302 to show both video imagery and spatial position and a fixed point in time.

In one embodiment according to the present method and apparatus a thincTrax PDA client was developed as a proof point for mobile device support. The thincTrax PDA client consumed map images from the map server, and delivered them to the device to allow zooming, panning, and scrolling on the PDA client. The architecture of the mobile application is similar to that of the core thin client library. A Model-View-Controller pattern is used to create several different interfaces to a single central data model. The mobile application connects to Map Services over the Internet and fetches map tiles for the currently displayed area. Feature data is provided by Data and Application services in the form of GeoRSS. The GeoRSS is parsed by a RSS library and imported into the application's central data store. The application then uses its native graphics libraries to represent the feature data on the map.

Mobile applications are especially well suited for low-bandwidth or sporadic Internet access. Since the application does not depend on a web browser, additional optimizations such as local tile caching can be introduced to counteract the limitations of the network.

The following represent different features of the present method and apparatus.

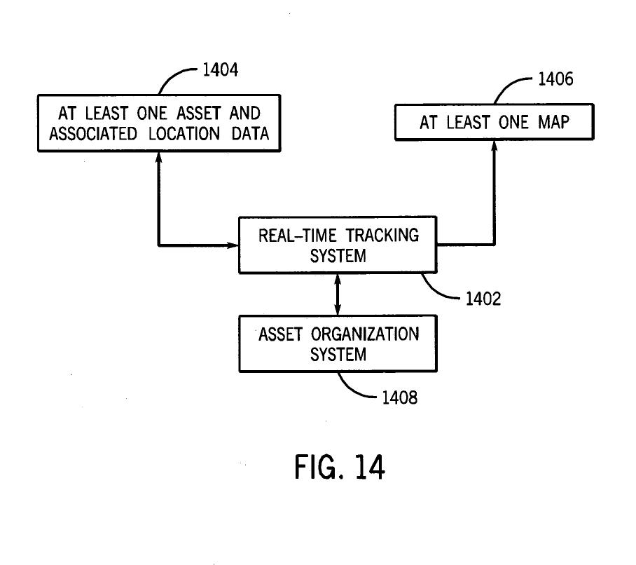

FIG. 14 is a block diagram of the tracking feature of the present method and apparatus. The tracking feature is implemented with a real-time tracking system 1402 that is operatively coupled to at least one asset and associated location data 1404, at least one map 1406 and an asset organization system, 1408. The real-time tracking system 1402 shows, based on the associated location data 1404, a position of the at least one asset on the at least one map 1406.

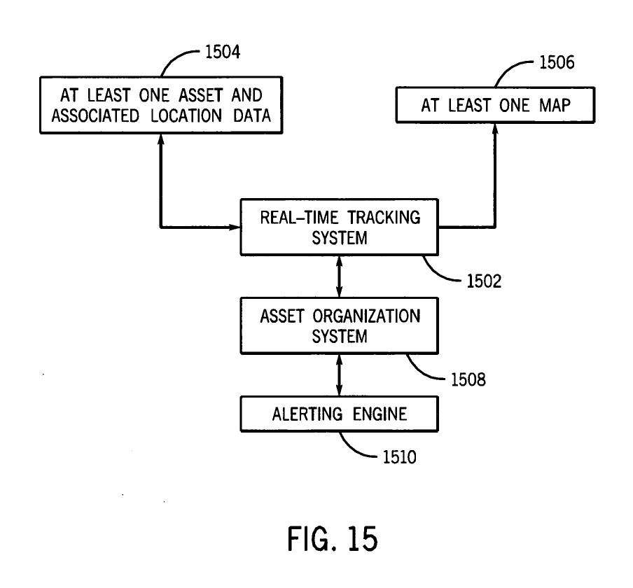

FIG. 15 is a block diagram showing the alerting feature of the present method and apparatus. The alerting feature may be implemented with a real-time tracking system 1502 that is operatively coupled to at least one asset and associated location data 1504, at least one map 1506, an asset organization system 1508 and an alerting engine 1510. As explained above the alerting engine 1510 is responsible for delivering audio alerts, visual alerts, text message alerts, email alerts, etc. in response to movement of the assets 1504 relative to the map 1506.

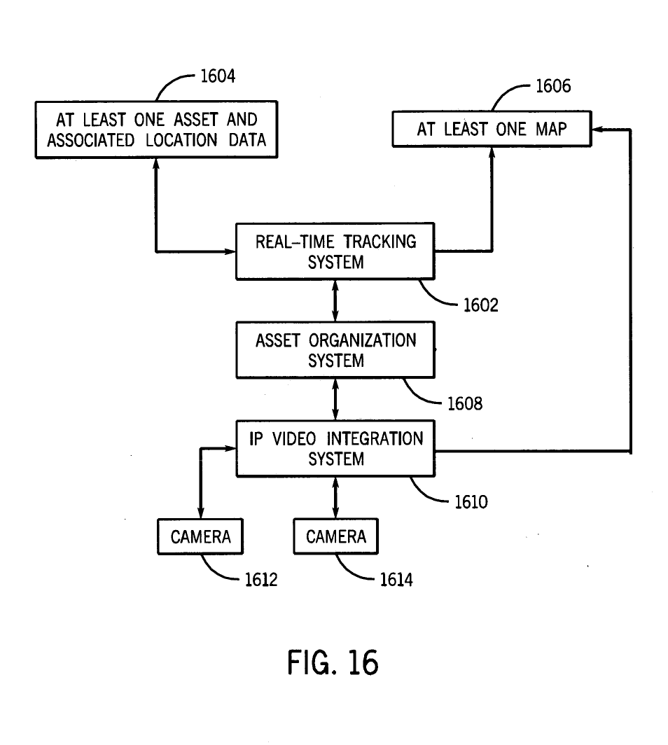

FIG. 16 is a block diagram showing the video feature of the present method and apparatus. The video feature may be implemented with a real-time tracking system 1602 that is operatively coupled to at least one asset and associated location data 1604, at least one map 1606, an asset organization system 1608 and video integration system 1610. As explained above the video integration system 1610 is responsible for taking video feeds from RTLSs, such as cameras 12 and 14 for example and linking the video data with the asset data on the map 1606.

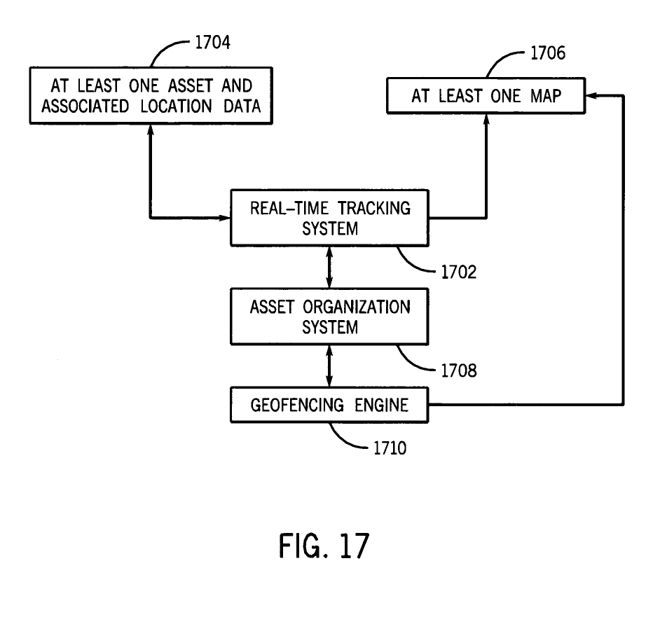

FIG. 17 is a block diagram showing the geo-fencing feature of the present method and apparatus. The geo-fencing feature may be implemented with a real-time tracking system 1702 that is operatively coupled to at least one asset and associated location data 1704, at least one map 1706, an asset organization system 1708 and the geo-fencing system 1710. As explained above the geo-fencing system 1710 is responsible for establishing regions on the map 1706 so that in combination with the real-time tracking system 1702 it may be determined when assets move in and out of the regions on the map 1706.

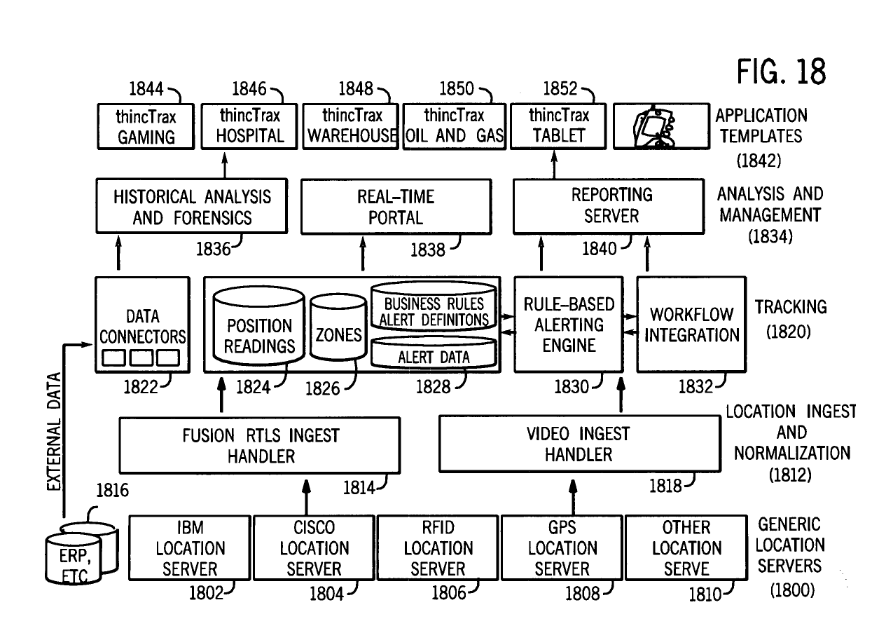

FIG. 18 depicts one embodiment of the thincTrax system architecture.

The first layer 1800 consists of Generic Location Servers (RTLS's). Data may be received from a variety of RTLSs, such as an IBM location server 1802, CISCO location server 1804, RFID location server 1806, GPS location server 1808, and other location servers 1810. The reason for this is that no single tracking technology works in every situation. Thus a typical implementation will ingest position information from several sensor systems.

The second layer is a Location Ingest and Normalization layer 1812. The Location Ingest and Normalization layer 1812 accepts generic position information from the RTLS's 1802, 1804, 1806, 1808, 1810. Using the FUSION engine 1814, the system normalizes the positions, de-conflicts the positions, and persists the information in a geospatial database 1816. The problem is that the RTLS's have different precision characteristics and will report different positions for the same object in a variety of formats. For example, sample formats may be longitude and latitude for objects tracked with GPS, X and Y coordinates for object tracked with active RFID tags inside a building, or specific time-stamped locations as tagged objects pass through readers. The role of the FUSION engine 1814 is to normalize and de-conflict the feeds to provide an integrated view of object positions. A video ingest handler 1818 may be separate from or be part of the FUSION engine 1814.

The third layer may be a tracking server 1820. After the object or asset positions are determined and persisted in thincTrax's geospatial database 1816, the tracking server 1820 processes the new positions, applies business rules, fires alerts, and takes action by integration with workflow management systems. The tracking server 1820 may have modules for data connectors 1822, position readings 1824, zones 1826, business rules alert definitions and alert data 1828, rule-base alerting engine 1830, and a reporting server 1832.

The fourth layer is analysis and management system 1834. The analysis and management system 1834 provides situational awareness, historical analysis, and reports. This information is presented to users in a lightweight Web 2.0 portal. The portal shows where objects are, where they have been, and provides the capability to find objects. The analysis and management system 1834 may have historical analysis and forensics 1836, animal tracking analysis 1838, and workflow integration 1840.

The fifth layer may consist of user interfaces or application templates 1846. The thincTrax application templates 1846 provide customized user interfaces for particular market verticals. This involves changing the dialogues, creating vertical specific rules, and tailoring the software. For example, the thincTrax application templates 1846 may include thincTrax gaming 1844, thincTrax hospital 1846, thincTrax warehouse, thincTrax oil and gas, and thincTrax table.

This is only one example of thincTrax archecture, which may take various other forms depending upon the application.

The following is one application of the present method and apparatus for Animal Disease Management.

For this example it is assumed that there is an outbreak of Hoof and Mouth disease in the US. This easily spread animal disease is devastating and it is critical that the extent of the disease be determined and animal management procedures established as quickly as possible. The first problem is to determine the affected areas from a few animals testing positive. By integrating with USDA's National Animal Identification System, thincTrax provides a time-based analytical environment to trace the affected animals back to their host farms, determine which animals have come in contact with the disease, and thereby highlight other areas requiring immediate Hoof and Mouse disease testing. Through this process the affected farms and geographical areas can be determined. Within an afflicted area it is essential that USDA establish a quarantine to prevent the disease from spreading. Using GPS, RFID, and other tagging technologies USDA can then tag all vehicles, personnel, assets, and even pets. Using thincTrax's real-time monitoring capability it can establish an isolation zone with geo-fences that fire alerts whenever vehicles or personnel enter or leave the isolation area. If the disease spreads, thincTrax's forensic capability may determine the disease vector, e.g. how the disease breached the isolation zone. By correlating the spread with the geo-positions and paths of tagged assets, thincTrax may suggest better ways to enforce isolation without causing undue burden on people and farmers within the affected areas. To support first responders and veterinarians, thincTrax may send alerts to their PDAs and Smart Phones, and even provide them with disease incident maps on mobile tablet computers. These systems may be fully integrated using standard networking technologies so that all first responders have full situational awareness and a common operating picture. The value of an animal disease management system is immense. Undoubtedly a critical livestock disease outbreak will occur within the United States. When this event occurs the challenge will be to manage it and thereby prevent critical damage to our agricultural industry. The tracking, analysis, and management capability according to the present method and apparatus will be an essential tool to help isolate a problem, determine which other areas are affected, establish geo-fences, and provide first responders with critical information.

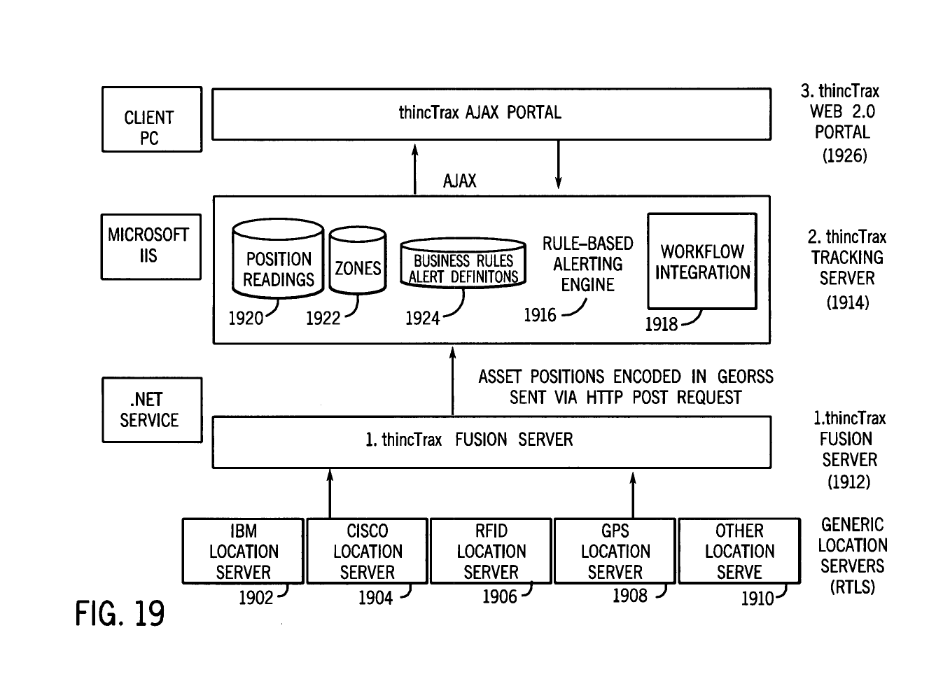

FIG. 19 depicts another embodiment of the thincTrax software architecture. In this embodiment there are generic location servers (RTLS), such as, IBM location server 1902, CISCO location server 1904, RFID location server 1906, GPS location server 1908, and other location servers 1910. These servers may be operatively coupled to a thincTrax fusion server 1912, which ingests data from the servers. The thincTrax fusion server 1912 provides asset positions encoded in GeoRSS sent via http post request.

A thincTrax tracking server 1914 may be operatively coupled to the thincTrax fusion server 1912. The thincTrax tracking server 1914 may include a rule-based alerting engine 1916 and a workflow integration 1918. The thincTrax tracking server 1914 may have databases, such as position readings 1920, zones 1922, and business rules and alert definitions 1924. A thincTrax AJAX portal 1926 may be operatively coupled to the thincTrax tracking server 1914.

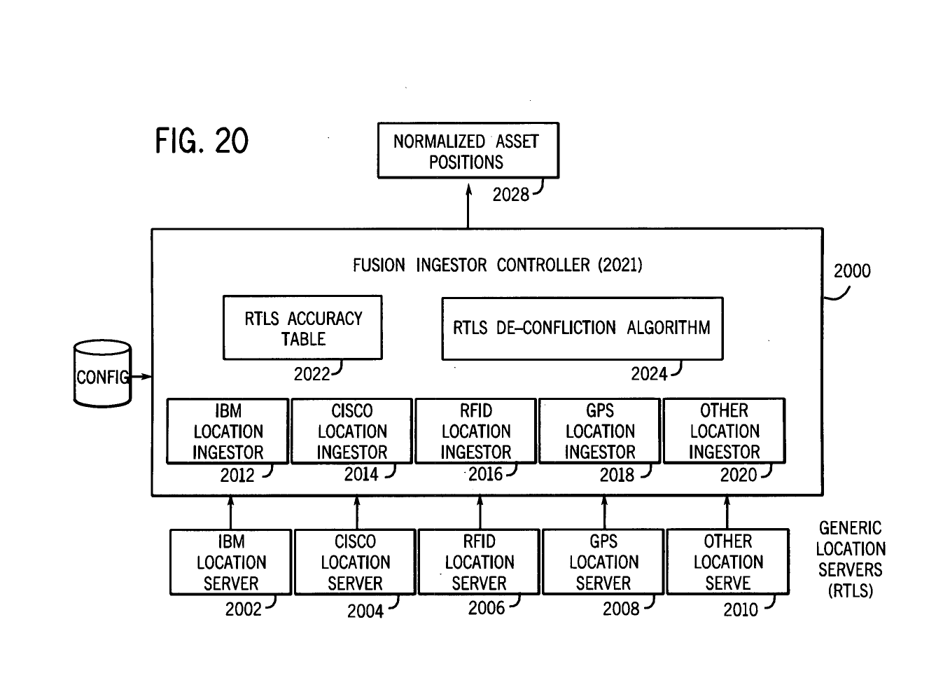

FIG. 20 depicts an embodiment of the thincTrax RTLS ingest server 2000. As in the FIG. 19 embodiment there are generic location servers (RTLS), such as, IBM location server 2002, CISCO location server 2004, RFID location server 2006, GPS location server 2008, and other location servers 2010. Corresponding thereto in the thincTrax RTLS ingest server 2000 are IBM location ingestor 2012, CISCO location ingestor 2014, RFID location ingestor 2016, GPS location ingestor 2018, and other location ingestors 2020. The ingestors ingest data from the servers regarding the positions of assets. A fusion ingestor controller 2021 may have an RTLS accuracy table 2022 and an RTLS de-confliction algorithm 2024. The fusion ingestor controller 2021 may also be operatively coupled to a configuration database 2026. The thincTrax RTLS ingest server 2000 provides normalized asset positions 2028.

In the FIG. 19 embodiment the thincTrax software consists of two servers and a Web 2.0 client portal. The components are: a thincTrax FUSION Server, a thincTrax Tracking Server and a thincTrax Web 2.0 Client Portal.

In this implementation both servers run on top of Microsoft IIS's web server and are implemented in NET. The thincTrax FUSION server accepts asset position information from RTLS's (Real-Time Location Servers), normalizes and de-conflicts the feeds using its proprietary FUSION algorithm based on configuration parameters, and publishes asset positions encoded as GeoRSS that are consumed by the thincTrax Tracking Server. The thincTrax Tracking Server ingests the new positions, determines which, if any, rules apply to the asset, and runs the alerting engine. The thincTrax AJAX Client Portal provides browser-based access to the asset positions, alerts, historical reports, and system configuration parameters.

The FUSION server is responsible for the ingesting position information from each RTLS (Real-Time Location Server), de-conflicting the positions to provide accurate position information, and normalizing the information across coordinate systems. The flow of data through the server consists of a connection to an RTLS either via actively polling the data source or listen for data to be pushed to the server. After getting the positional information, the stream of data in reformatted into a normalized internal structure to the FUSION Server. Data is then scrutinized to verify the data, then transformed into GeoRss, and then pushed to ThincTrax for loading into the ThincTrax system.

Each RTLS publishes a stream of position reports as the Assets being tracked move. Each position report includes an Asset ID identifier that is associated with the particular tag tracked by the RTLS, the x, y (and sometimes z) positions of the asset, timestamp, and other metadata. The metadata may include the asset name, asset category, asset group, information about the tracking device, etc.

The FUSION server may run as a NET service or as a Windows console application. It may consist of classes that provide a mechanism to poll a url for new position reports or may listen on a port for other applications to push reports to the server. For each supported RTLS there is a specific function called an ingestor that knows the specifics of the information provided by the RTLS in its position reports.

Ingestors and RTLS sources are configured via a configuration file. Configuration options include whether the ingestor will listen or poll for data, how often to poll, what the delay is for the deconfliction algorithm if there is more than on RTLS configured for a single asset. If there is more than one RTLS collecting information about the same asset, the FUSION server allows for de-conflicting this information. Information from each RLTS is collected and after a configurable amount of time, all position reports collected for that asset, are compared for accuracy, to select the most accurate position report for that group of reports. The position report is then sent to ThincTrax for ingestion and processing.

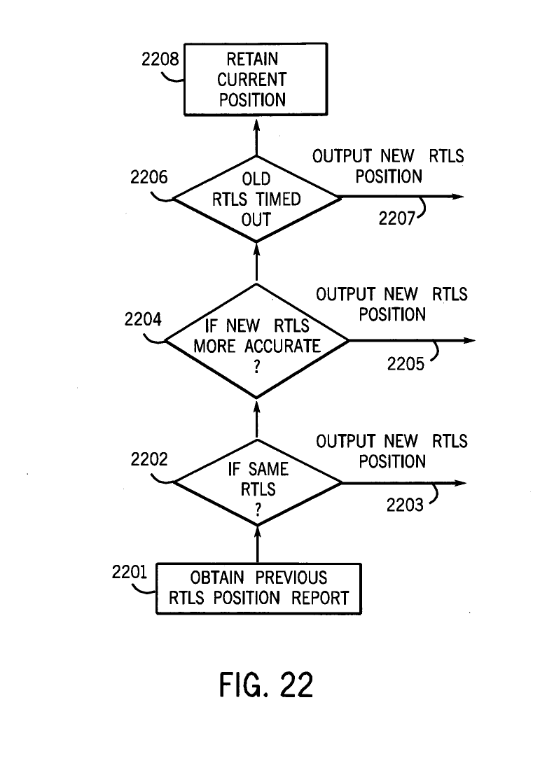

FIG. 22 depicts a flow diagram of an embodiment of the procedures for ingesting data from the RTLS's. Initially a previous RTLS position report is obtained (step 2201). If it is a same RTLS (step 2202), then new RTLS position is output (step 2203). If it is a new RTLS that is more accurate (step 2204), then new RTLS position is output (step 2205). If an old RTLS timed out (step 2206), then new RTLS position is output (step 2207). Otherwise, the current position is retained (step 2208).

The purpose of the FUSION de-confliction algorithm is to provide an accurate position report when an asset is being tracked by multiple RTLS's. As part of the configuration, the accuracy and time for each RTLS is provided to the FUSION controller in the form of a table.

TABLE 1
RTLS Accuracy Configuration Table.

| RTLS | Accuracy | Time Out |
|---|---|---|
| RTLS 1 | 1 foot | 10 seconds |
| RTLS 2 | 2 feet | 30 seconds |
| RTLS 3 | 20 feet | 60 seconds |
| . . . | . . . | . . . |

When a new position report is received from one of the ingestors, the de-confliction algorithm proceeds as follows. Assume there are n RTLS's numbered RTLS₁ . . . RTLSₙ. Let pos_{t,j} be the position of the asset observed by RTLSⱼ at time t. Let Aⱼ be the accuracy of RTLSᵢ for j=1, . . . , n specified in the RTLS Accuracy Configuration Table. Assume that this asset was last observed at time tᵢ by RTLSᵢ. The de-conflication algorithm is:

If the new RTLS is more accurate than the previous RTLS, e.g. if Aⱼ<=Aᵢ, the current asset position is pos_{t,j}

If the new RTLS is less accurate than the previous RTLS, e.g. if Aⱼ>Aᵢ, but the previous position has timed out, t−tᵢ>timeoutᵢ, the current asset position is pos_{t,j}

If the new RTLS is less accurate than the previous RTLS, e.g. if Aⱼ>Aᵢ, and previous position has not timed out, t−tᵢ<timeoutᵢ, retain pos_{t,i}

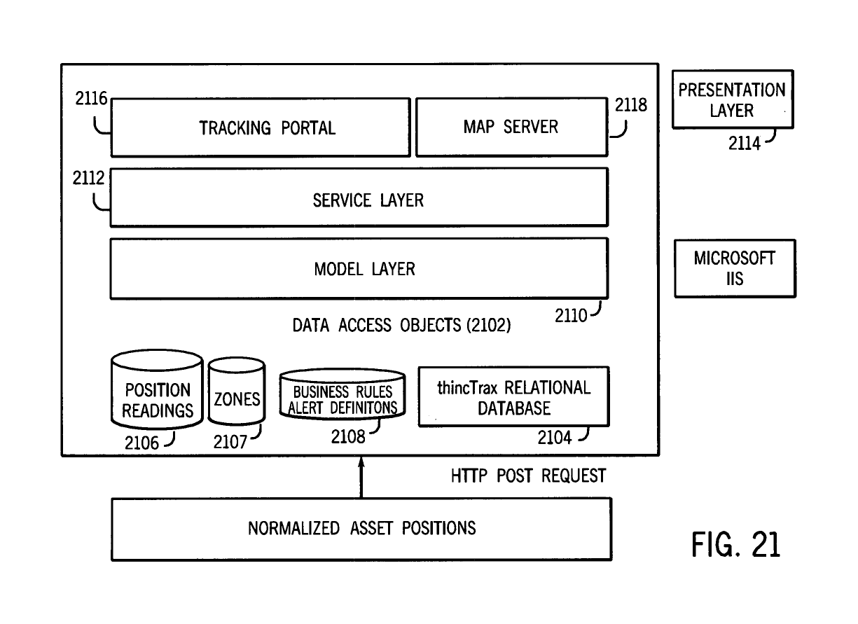

FIG. 21 depicts an embodiment of the thincTrax tracking server architecture. Data access objects 2102 may have a thincTrax relational database 2104 with a position readings database 2106. The data access objects 2102 are part of the thincTrax tracking server architecture. Also part of the thincTrax tracking server architecture are a model layer 2110, a service layer 2112, a presentation layer 2114. The presentation layer 2114 may have a tracking portal 2116 and a map server 2118.

Architecture of the thincTrax Server may consist of multiple layers, for example, a DAO Layer, a Model Layer, a Service Layer, and a Presentation Layer.

The DAO layer provides an object representation of the thincTrax relational database. In this implantation, the top level tables in our relational database are associated with C# DAO classes. These are the classes on thincTrax performs standard CRUD operations. The DAO layer provides a convenient programming interface for database operations and database transactions. This implementation uses NHibemate for the object relational mapping tool.

The model layer consists of business model objects. These C# objects are object representations of the database objects. They are objects used by the service layer to manage data within the system.

The service layer is responsible for managing the model and DAO objects. It is responsible for handing off objects to the presentation and feed layers and exposes an interface for saving model objects via the DAO without requiring the presentation layer and feed layer to have direct access to the DAO.

The presentation layer consists of the user interface and communicates with the service to request, save, and process information for display. It includes access to the real-time asset position feeds and a WMS map server that provides background imagery. The positions of the assets are sent to the tracking portal as GeoRSS.

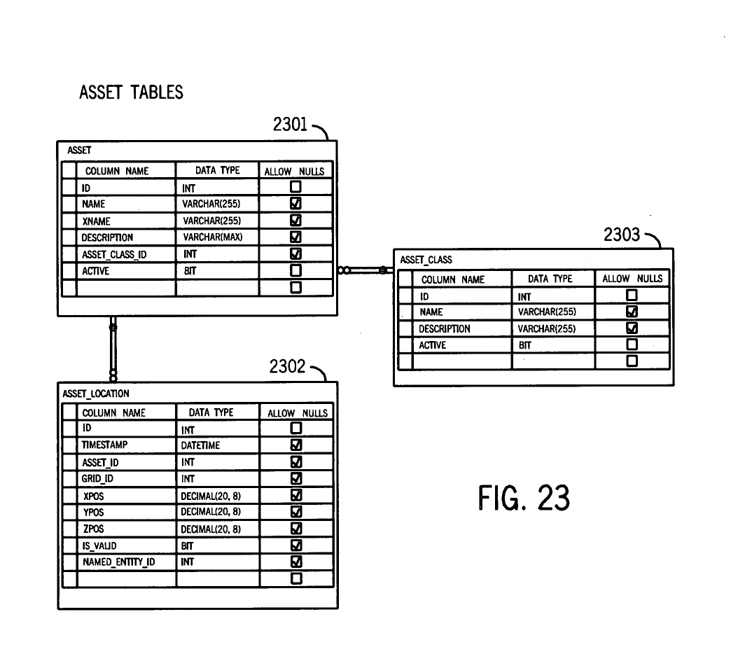

FIG. 23 depicts one embodiment of the asset tables that are contained in the databases. The asset tables may be made up of at least a table of assets 2301, a table of asset locations 2302, and a table of asset classes 2303.

Assets can be added in two ways, either via a configuration page or automatically added if an RTLS position report contains a new asset. The required information for an asset includes Name, External Name, Category, and Description. The name is user friendly name that is stored by the ThincTrax system. External name is a non-descriptive name that is provided to ThincTrax from an RTLS system. An example of External Name would be a mac id address from an active rfid tag. An example of Name for this asset might be “Report 1.”

Assets are managed internally by an ID that is created within the ThincTrax system.

Assets can also be edited. Name, External Name, Category, and Description are all editable attributes of the Asset. Assets can be deactivated from the system. Due to maintaining referential integrity and keeping correct historical information, Assets are not deleted from the system, instead they are just “turned off.”

Groups for business alerting rules are a mechanism to create ad hoc groupings of assets, regardless of the asset category, and are used primarily by business alerting rules. Group definitions include Name, Description, and an active indicator. To maintain referential integrity, groups can only be deactivated and not deleted. The Name, Description, and the active indicator fields can be edited for update. Assets are assigned to groups while editing a group. Each asset may be in many different groups.

Categories for portal display are sets of assets that are used to determine which assets are displayed in the portal. A category can be added manually to the system or can be generated “on the fly” via the position report feed from the FUSION Server. If a category is sent on the position report feed and that category is not currently in the system, the system will automatically create the category and associate the asset to that category. If the category is not listed in the position report feed, the asset will be placed in a default category.

If, during position report ingestion, a category of the asset is different from the one listed in the database, the category will be updated to reflect the category on the feed.

Categories consist of Name, Description, and an Active Indicator. Editing of the category can occur and the Name, Description and Active Indicator can be changed.

To enforce referential integrity, the category cannot be deleted, just deactivated.

Assets can be added to a category manually. An asset can be in only a single category.

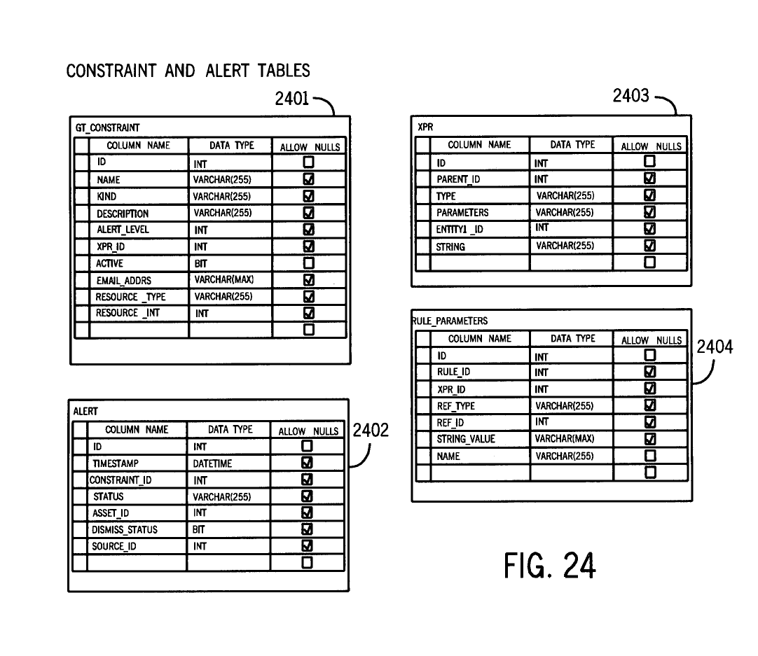

FIG. 24 depicts one embodiment of the constraint and alert tables that are contained in the databases. The asset tables may be made up of at least a table of constraints 2401, a table of alerts 2402, a table of xpr 2403 and a table of rule parameters 2403.

Rules are comprised of expressions. Simple expressions can be “anded” together to form more complex rules. Each rule is essentially an expression template that is instantiated with variables to form an expression. Each expression is implemented as a model object and presentation control that inherits from an IExpression interface. One of the parameters in the template is the group of assets that the rule applies to. The presentation control is responsible for validating data input for the selected expression. The expression class is then added to a Constraint object.

Rules are constructed via a wizard interface that provides a mechanism to select from the available expressions, entering the required information for each expression, and adding the expression to the constraint. After adding the expression, the expression is added to the constraint object and display in data grid format. Multiple expressions are “anded” together. They can be removed from the constraint via a delete button on the data grid.

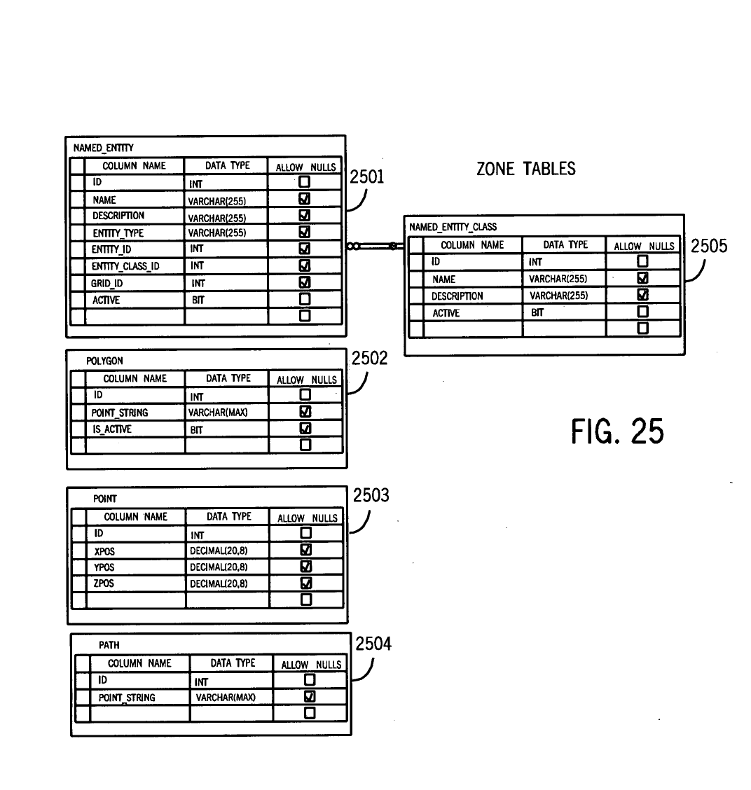

FIG. 25 depicts one embodiment of the zone tables that are contained in the databases. The asset tables may be made up of at least a table of named entities 2501, a table of polygons 2502, a table of points 2503, a table of paths 2504 and a table of named entity classes 2503.

A zone is a geospatial region that the user marks on the screen. Categories for Zones can also be created. These are groupings are logical groups of zones that can be turned on or off via the portal page. Zones are added to categories during their creation on the portal page. A Zones category is edited on the portal page as well.

The following steps are one example of Asset Position Ingest.

1. The exposed endpoint ThincTrax provides is an implementation of an IHttpHandler.

2. When FUSION sends a position report, in the form of GeoRSS, the GeoRSS is sent to the ThincTrax server using an http post request.

3. The extended GeoRSS encoding the asset position is passed to the Service Layer for processing.

4. The GeoRss is deserialized through an Ingestor to convert it to a C# object, and then position and metadata for the asset is exposed via GeoRss object model representation.

5. The deserialized data is then accessible via object references and used to process the information.

6. The information gathered about an asset from a position report includes TimeStamp, External Name, Name, Latitude, Longitude, Category, Description, and Grid.

7. The where clause for GeoRSS may include a GML shape. The only GML shape that thincTrax supports for an asset position is a GML point.

8. If the shape is not a point, the position report is dismissed and an error is reported in the system logs.

9. If the position report contains a valid point and represents a valid position, the asset corresponding to this position report is queried by the DAO layer from the asset table using the external name as a key.

10. If the asset is found, an asset object is created by the DAO and returned to the service layer where the assets name, description, category are updated if information has changed.

11. If the category for the asset does not exist, it will be created and the asset will be associated with that new category.

12. If the asset does not exist, it will be created in the system. A reference to the asset is now available and processing continues.

13. A position report object is then created from the information in the GeoRSS. The timestamp sent is converted to UTC time and the position report is saved.

14. Each asset position if associated with a grid. There is a default grid which most asset locations are associated with but in the case where there are multiple floors in a building, the lat, lon could be the same but they are different floors. Different floors will have a different map on the web portal page. The grid is a mechanism to allow for the asset location to be associated with the correct map. The grid can be geodetic or Cartesian depending on the type of calculations needed.

15. After the position report has been stored, the asset position is passed within the service layer to determine the current zone that the asset is in. The service layer asks the DAO layer to return all zones that are close to the asset position. The list of zone objects that is returned is then compared with the position of the asset to determine if the asset is in the zone.

16. Because asset in zone calculations are processing intensive, the calculations are done at this point to relieve the web portal server code from having to calculate asset in zone figures on every request.

17. Also, after the position report has been stored, the asset is passed within the service layer for rule processing.

The following steps are one example of Business Rule Processing.

1. Since assets are in both groups and categories, a query is run to find all rules that need to be evaluated for this asset.

2. Rules for the category the asset is in are returned.

3. Rules for the groups that the asset is in are returned.

4. Finally these rules are evaluated for this asset only. While rules are applied to categories and groups, these grouping are a way to apply a Rule to a large number of assets, versus applying a rule to one asset at a time.

5. If there is a need to apply a rule to only one asset, a new group should be created that will consist of only that asset.

6. During rule processing, if a rule's expressions all meet there specified criteria, an alert is generated and stored in an alert table.

7. The time the alert was generated, the rule id of the rule that was evaluated that the generated the alert, and the asset id are some of the attributes that are stored for an alert.

8. This will also invoke the notification server. They rule service hands the constraint and alert objects to the notification service and instructs it to send a email, SMS text message, or any other type of communication if that has been configured.

9. End of processing for the asset location.

The following steps are one example of Data Transfer To and From the Map Client and Server.

1. When a request for the map portal page is made, IIS interprets that request and begins to the load the map aspx page.

2. There is only one set of data that is required for this request. This data is the information in the content panel on the left side of the display.

3. The data for the content consists of Categories of Assets and the Assets that are in those categories.

4. When the page begins to load, the Map page (presentation layer) makes a call into the Service Layer (Asset Service) and requests all Categories of Assets and all Assets in each Category.

5. The Asset Service then takes that request and asks the DAO layer to execute this request.

6. The collections of assets and categories are returned to the service layer and then passed to the presentation layer.

7. The presentation layer then creates a tree view control and populates the control with the data returned from the service layer.

8. This same process occurs for the Zone Tree View as well.

9. Once the page has completed it server lifecycle and it send to the browser, all subsequent updates of the data in both the Asset Tree View and the Zone Tree View occur via Ajax and the ASP.NET update panel.

10. The update times for each of these controls occur at a configurable amount of time.

11. When the client determines it is time to update the tree view, via an ASP.NET AJAX timer control, JavaScript code is invoked to post a request to server for an updated tree view.

12. The server goes through steps 4-8 above and returns just the HTML associated with either the AssetTreeView Control or the ZoneTreeView Control.

13. Each controls contains buttons for view current asset positions or paths.

14. When that button is clicked, it fires and event in javascript announcing to the listeners that it has been clicked, passing the category id of the category that was selected.

15. The JavaScript managing the asset feed contains a collection of currently selected categories.

16. The category selected is added to the internal collection and the url for the assets is updated to get this resource from the server.

17. Here is an example of the URL that sent to the server, via AJAX, to request information from the server.

18. http://localhost/GeoTrackClient/Feeds/AssetFeed.ashx/Class-2?max-results=2000&dateformat=yyyy-MM-ddTHH:mm:ssZ&gridId=1&thincUniqueVal=1202831588000

19. In this case AssetFeed.ashx gets invoke (Feeds Layer). The Class-2 from the above url is parsed from the url. Class-2 is equivalent to Category with the ID of 2. This request is passed to the service layer and a request for the current locations for all assets in this category is eventually passed to the DAO layer to execute the query.

20. The collection of assets is returned to the service layer.

21. The service layer then transforms the assets and their locations into GeoRSS.

22. The AssetFeed.ashx then responds with the GeoRSS that is return from the service layer.

23. The GeoRSS is received and parsed client side via JavaScript and the data makes its way to the map.

24. This method is used for Zones, Alerts, and Charts as well.

For processing request information from the client, requests are handled on the server first by IHttpHandlers. These handlers accept the web request, parse the request, and pass the pertinent information from the request along to the Service Layer for the processing.

Selecting the watch button on an asset category will result in a result being sent to the server from the client via ajax, on configurable intervals, to request current location information for all assets in that category. They server simply queries for all assets in the categories requested, gathers their latest position report, transforms that information to GeoRss, and responds to the client request with the GeoRSS.

If the request for assets includes paths, path processing will be invoked on the server side for this request. The resource on the on the server that is invoked by the request really isn't a resource. It's more like a flag sent from the client that instructs the server to send path information for a certain period of time for the asset categories listed in the request.

During path generation, based on the time window for the path request, the asset locations are grouped into 20 segments. For each segment, speed is calculated. This speed is then represented on the client via segment width. The width of the segment is set via a proprietary style property that pertains to each GeoRss item that instructs the client on how to display the data. Paths fade over time. Besides with of the path segment, its opacity is set by the server based on how long ago that path was created. The farther in the past the path was created, the less opaque the path segment becomes.

The above description is representative of how Zone, Alert, and Chart requests are made from the client and then sent back from the server.

The following benefits result from thincTrax embodiments according to the present method and apparatus for tracking: flexibility to capture and use data from a number of identification and tracking systems; improved data accuracy through conflict identification; real-time post event tracking of assets, people, vehicles, etc.

In general terms thincTrax is an innovative system for real-time tracking and analysis. Features of the system according to the present method and apparatus include: generic tracking system that ingests position data from any number of RTLS's: fusion engine that ingests, normalizes, de-conflicts, and persists RTLS feeds information to provide accurate locations; real-time geospatial tracking database that include assets, positions, history, zones, and alerts; an alerting engine with configurable rules; ability to use both outside maps with satellite imagery and inside floor plans to show asset positions; and connections to both “push” and “pull” feeds.

Some embodiments according to the present method and apparatus may utilized a Web 2.0 AJAX tracking portal. Such embodiments may enable the following features: show asset positions on a map, imagery, floor plan, shelf layout, or in generally any type of background imagery; provides rich methods to show breadcrumb trails that fade out through time and show characteristics of the path such as speed and locations where the asset was stationary; a timeline linked to s geospatial portal; tracking system that integrate location information with real-time video streaming video; flexible reporting module; and visual characteristics to show trails.

In an embodiment of the present method and apparatus a configurable alert engine that may use configurable rule templates wherein rules may be combined and may be based on zones drawn in the portal.

Also in an embodiment of the present method and apparatus historical analysis may be integrated with tracking capability. Such historical analysis may include: analyzing alerts by object, category, class, zone, etc. using linked charts; analyzing the location of objects using heat maps; and analyzing paths of assets. Furthermore, incident forensics according to the present method and apparatus show a sequence of an incident using a timeline; and may correlate a timeline with video feeds.

The present apparatus in one example may comprise a plurality of components such as one or more of electronic components, hardware components, and computer software components. A number of such components may be combined or divided in the apparatus.

The present apparatus in one example may employ one or more computer-readable signal-bearing media. The computer-readable signal-bearing media may store software, firmware and/or assembly language for performing one or more portions of one or more embodiments. The computer-readable signal-bearing medium in one example may comprise one or more of a magnetic, electrical, optical, biological, and atomic data storage medium. For example, the computer-readable signal-bearing medium may comprise floppy disks, magnetic tapes, CD-ROMs, DVD-ROMs, hard disk drives, and electronic memory.

The steps or operations described herein are just exemplary. There may be many variations to these steps or operations without departing from the spirit of the invention. For instance, the steps may be performed in differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

We claim:

1. An apparatus, comprising:
at least one of an identification tag and a video feed associated with at least one asset;
at least one real time location server that operatively interfaces with the at least one of the identification tag and the video feed; and
real-time data analysis and tracking system that ingests asset location data for at least one asset from at least one real time location server.

2. The apparatus according to claim 1, wherein the real-time data analysis and tracking system has a real-time alerting rules engine, and wherein assets being tracked are organized into at least categories and groups, and wherein the categories are used to manipulate visibility of sets of assets in a portal and wherein the groups are used by the real-time alerting rules engine.

3. The apparatus according to claim 1, wherein the real-time data analysis and tracking system provides current and historical asset positions that are stored in a geospatial database having a plurality of tables, and wherein the plurality of tables comprises at least the following tables: assets being tracked; categories of assets for portal visibility; groups of assets for alerting engine; current and historical asset locations; zones; business rules; and alerts.

4. The apparatus according to claim 1, wherein the asset location data comprises at least one of a plurality of position information and a plurality of video data for the at least one asset, and wherein the position data is derived by the real-time location servers from a plurality of radio frequency identification tags, and wherein the video data is derived from a plurality of video sources.

5. The apparatus according to claim 1, wherein the asset location data is ingested through both push and pull feeds, wherein for push feeds the apparatus is activated when asset location data arrives, and wherein for pull feeds the apparatus periodically requests new asset locations from the pull feeds.

6. An apparatus, comprising
at least one location server having at least one output that provides asset location data related to at least one asset;
normalization system having at least one input operatively coupled respectively to the output of the at least one location server, and having at least one output for providing normalized location data; and
tracking and processing system having at least one input operatively coupled respectively to the at least one output of the normalization system, and having at least one output for providing tracked asset information.

7. The apparatus according to claim 6, wherein the apparatus further comprises an analysis and management system having at least one input operatively coupled respectively to the at least one output of the tracking and processing system, and having at least one output for providing reportable information regarding the at least one asset

8. The apparatus according to claim 7, wherein the apparatus further comprises at least one user interface having at least one input operatively coupled respectively to the at least one output of the analysis and management system.

9. The apparatus according to claim 6, wherein the asset location data comprises at least one of position information and video data.

10. The apparatus according to claim 6, wherein the apparatus further comprises a report engine operatively coupled to the analysis and management system.

11. The apparatus according to claim 6, wherein the apparatus further comprises a workflow integration engine operatively coupled to the analysis and management system.

12. The apparatus according to claim 6, wherein normalizing positions of the asset, de-conflicting the positions of the assets, and persisting resulting asset information are performed in a fusion engine.

13. The apparatus according to claim 6, wherein the tracking and processing system comprises asset tracking, processing new asset positions, applying business rules, firing alerts, and taking action by integration with workflow management systems.

14. The apparatus according to claim 6, wherein the tracking and processing system comprises a geofence system that defines a predetermine area.

15. The apparatus according to claim 6, wherein the analysis and management system provide at least one of situational awareness, historical analysis, and reports.

16. The apparatus according to claim 6, wherein the user interfaces comprise at least one application template.

17. The apparatus according to claim 16, wherein the user interfaces comprise at least one of changing dialogues, creating vertical specific rules, and tailoring software.

18. A method, comprising:
receiving, in a first layer, asset location data related to at least one asset from a variety of real-time location servers;
accepting, in a second layer, the data from the first layer and normalizing positions of the asset, de-conflicting the positions of the assets, and persisting resulting asset information in a geospatial database;
tracking and processing, in a third layer, the at least one asset based on the asset information from the second layer, and providing tracked asset information;
analyzing and managing, in a fourth layer, the tracked asset information from the third layer to provide reportable information regarding the at least one asset; and
providing, in a fifth layer, user interfaces to the reportable information of the fourth layer.

19. The method according to claim 18, wherein the asset location data is at least one of position information for the at least one asset and video data for the at least one asset.

20. The method according to claim 18, wherein the real-time location servers receive data from a plurality of radio frequency identification tags.

21. The method according to claim 18, wherein normalizing positions of the asset, de-conflicting the positions of the assets, and persisting resulting asset information are performed in a fusion engine.

22. The method according to claim 18, wherein the tracking and processing comprises asset tracking, processing new asset positions, applying business rules, firing alerts, and taking action by integration with workflow management systems.

23. The method according to claim 18, wherein the tracking and processing comprises formation of a geofence system that defines a predetermine area.

24. The method according to claim 18, wherein the analyzing and managing provide at least one of situational awareness, historical analysis, and reports.

25. The method according to claim 18, wherein the user interfaces comprise application templates.

26. The method according to claim 18, wherein the user interfaces comprise at least one of changing dialogues, creating vertical specific rules, and tailoring software.

27. An apparatus, comprising:
a fusion server having a plurality of location ingestors operatively coupled respectively to a plurality of real time location servers;
a tracking server operatively coupled the fusion server, the tracking server having real-time alerting rules engine and workflow integration, the tracking server also having a position readings database, a zones database and a business rules and alert definitions database; and
a web 2.0 portal having an AJAX portal.

28. The apparatus according to claim 27, wherein the fusion server comprises real time location server accuracy table and real time location server de-confliction algorithm for processing respective information from location ingestors, wherein a real-time geospatial asset position database is operatively coupled to the fusion server, and wherein the fusion server produces normalized asset positions.

29. The apparatus according to claim 28, wherein assets being tracked are organized into at least categories and groups, and wherein the categories are used to manipulate visibility of sets of assets in its portal and wherein the groups are used by a real-time alerting rules engine.

30. The apparatus according to claim 29, wherein current and historical asset positions are stored in a geospatial database having a plurality of tables.

31. The apparatus according to claim 30, wherein the plurality of tables comprises at least the following tables: assets being tracked; categories of assets for portal visibility; groups of assets for alerting engine; current and historical asset locations; zones; business rules; and alerts.

32. The apparatus according to claim 27, wherein the location ingestors receive asset location data, and wherein the asset location data comprises at least one of a plurality of position information and a plurality of video data for the at least one asset, and wherein the position data is derived by the real-time location servers from a plurality of radio frequency identification tags, and wherein the video data is derived from a plurality of video sources.

33. An apparatus, comprising:
at least one asset and associated asset location data;
at least one map;
real-time tracking system that shows, based on the associated location data, a position of the at least one asset on the at least one map; and
asset organization system operatively coupled to the real-time tracking system.

34. The apparatus according to claim 33, wherein the map is at least one of an outside map and an inside map.

35. The apparatus according to claim 33, wherein the map is interactive and supports panning and zooming and automatically updates when new position information for the at least one asset becomes available.

36. The apparatus according to claim 33, wherein the asset organization system displays at least one of alerts, and event timeline, and analysis charts related to the at least one asset.

37. The apparatus according to claim 33, wherein asset positions on the map are displayed using a “breadcrumb” trail encoded with visual cues to show historical positions of the asset.

38. The apparatus according to claim 37, wherein history in a trail of the asset is encoded using lightness and wherein the trail gradually fades out over time to prevent the display from becoming overly, busy, wherein a thickness of the trail varies to encode a speed of the asset at a particular point, and wherein the trail encodes the various points where the object stopped using filled geometric shapes.

39. An apparatus, comprising:
at least one asset and associated asset location data;
at least one map;
real-time tracking system that shows, based on the associated location data, a position of the at least one asset on the at least one map and on at least one time line;
asset organization system operatively coupled to the real-time tracking system; and
alerting engine operatively coupled to at least the asset organization system, the alerting engine generating at least one alert for at least one predetermined action related to the at least one asset.

40. The apparatus according to claim 39, wherein when the alerting engine generates an alert, generates a symbol that appears on the real-time map, generates an audio ping, and generates graphical alerts on a timeline.

41. The apparatus according to claim 39, wherein representations of the alert are linked so that mousing over the alert on the timeline causes the asset generating the alert, a location of the asset, and a breadcrumb trail of the asset to highlight on the map.

42. The apparatus according to claim 39, wherein alerts are linked between assets on the at least one map, on an alerts tab, and on a timeline.

43. The apparatus according to claim 39, wherein the alerting engine has alert templates that comprise at least one of: Asset Close to Asset; Asset Close to Zone; Asset Enter/Leave Zone; Asset Not Moving; Asset Speeding; Maintain Asset Signal; Zone Population; Day of Week; and Time of Day.

44. An apparatus, comprising:
at least one asset and associated asset location data;
at least one map;
real-time tracking system that shows, based on the associated location data, a position of the at least one asset on the at least one map; and
video integration system that provides spatial and situational awareness of an asset operatively coupled to the real-time tracking system, the video integration system providing access to real-time streaming video feeds directly from a portal by clicking on icons embedded in the map.

45. The apparatus according to claim 44, wherein the video feeds access cameras at particular locations indicated by an icon on the map.

46. The apparatus according to claim 44, wherein video feeds of a respective asset are integrated with a timeline to provide both spatial and video forensics of an historical incident.

47. An apparatus, comprising:
at least one asset and associated asset location data;
at least one map;
real-time tracking system that shows, based on the associated location data, a position of the at least one asset on the at least one map; and
a geofencing engine that establishes a defined area, a geofence, on the map;
wherein an asset crossing the geofence is detectable.

48. The apparatus according to claim 47, wherein the geofence defines a closed area on the map.

49. An apparatus, comprising:
a tracking system that ingests asset location data of assets from a plurality of real time location servers;
the tracking system having:
a fusion engine that ingests, normalizes, de-conflicts, and persists real time location server feed information to provide accurate locations of the assets;
a real-time geospatial tracking database that includes asset information; and
an alerting engine with configurable rules;
wherein the apparatus uses both outside maps and inside maps to show asset positions, and connects to at least one of “push” and “pull” feeds.

50. The apparatus according to claim 49, wherein the asset information comprises at least one of asset identification, positions, history, zones, and alerts.

51. An apparatus, comprising:
a plurality of radio frequency identification tags attached respectively to a plurality of animals;
a plurality of real time location servers that provide asset location information based at least on the radio frequency identification tags on the animals;
at least one map and at least one timeline;
real-time tracking system that shows, based on the asset location data, positions of the animals on the at least one map and on at least one time line; and
alerting engine operatively coupled to at least the real-time tracking system, the alerting engine generating at least one alert for at least one predetermined action related to positions of the animals.

52. The apparatus according to claim 51, wherein when the alerting engine generates at least one of symbols that appears on the map, audio pings, and graphical alerts on the timeline.

53. The apparatus according to claim 51, wherein representations of the alert are linked so that mousing over the alert on the timeline causes the asset generating the alert, a location of the asset, and a breadcrumb trail of the asset to highlight on the map.

54. The apparatus according to claim 51, wherein alerts are linked between assets on the at least one map, on an alerts tab, and on a timeline.

55. The apparatus according to claim 51, wherein the alerting engine has alert templates that comprise at least one of: Asset Close to Asset; Asset Close to Zone; Asset Enter/Leave Zone; Asset Not Moving; Asset Speeding; Maintain Asset Signal; Zone Population; Day of week; and Time of Day.

56. The apparatus according to claim 51, wherein the apparatus uses both outside maps and inside maps to show positions of the animals.

57. The apparatus according to claim 51, wherein the apparatus further comprises a geofencing engine that establishes a defined area, a geofence, on the map, and wherein an animal crossing the geofence is detectable.
